(19) United States
(12) Patent Application Publication
(10) Pub. No.: US 2026/0289731 A1
(43) Pub. Date: Sep. 24, 2026

(54) INFORMATION PROCESSING DEVICE, INFORMATION PROCESSING METHOD, PROGRAM, IMAGE PROCESSING DEVICE, AND IMAGE PROCESSING METHOD

(71) Applicant: Sony Semiconductor Solutions Corporation, Atsugi-shi, Kanagawa (JP)

(72) Inventor: Seichi OTSUKI, Kanagawa (JP)

(73) Assignee: Sony Semiconductor Solutions Corporation, Atsugi-shi, Kanagawa (JP)

(21) Appl. No.: 19/475,462

(22) PCT Filed: Apr. 18, 2024
(86) PCT No.: PCT/JP2024/015477

§ 371 Date: Oct. 15, 2025

Related U.S. Application Data
(60) Provisional application No. 63/462,036, filed on Apr. 26, 2023.

(51) Int. Cl. G06T 5/50; G06T 5/60

(52) U.S. Cl. CPC G06T 5/50; G06T 5/60; G06T 2207/20081

(57) ABSTRACT

Provided is an environment in which a sensor output of a spectroscopic sensor can be handled without considering a variation in spectral sensitivity of the spectroscopic sensor. An information processing device according to the present technology includes a coefficient calculation unit configured to calculate a coefficient included in a conversion algorithm for converting first sensor output into different output, the first sensor output being spectral information output by a first spectroscopic sensor, wherein the coefficient calculation unit calculate the coefficient so that the different output obtained by inputting the first sensor output to the conversion algorithm approaches second sensor output, the second sensor output being spectral information output by a second spectroscopic sensor different from the first spectroscopic sensor.

### CROSS REFERENCE TO RELATED APPLICATIONS

This application claims priority to, and the benefit of, U.S. provisional patent application Ser. No. 63/462,036 filed on Apr. 26, 2023, incorporated herein by reference in its entirety.

### TECHNICAL FIELD

The present technology relates to an information processing device, an information processing method, a program, an image processing device, and an image processing method, and particularly relates to a technology for spectral sensitivity variation of a spectroscopic sensor.

### BACKGROUND ART

A spectroscopic sensor (multi spectrum sensor) for obtaining an image representing the wavelength characteristic of light from a subject, in other words, a plurality of narrowband images to be analysis images of spectral information (spectral spectrum) of the subject is known. The plurality of narrowband images obtained by the spectroscopic sensor is used for a spectroscopy application that performs various types of analysis of a subject, such as analysis of a growth state of vegetables and analysis of a human skin state.

For example, PTL 1 below discloses a technique in which in a soil analysis method of irradiating the soil with light and analyzing the characteristic of the soil from a soil spectrum obtained from reflected light reflected by the soil, a plurality of waveform groups approximating the waveform is generated from a set of waveforms of soil spectra obtained from a plurality of soils, a feature spectrum in each of the waveform groups is obtained, and the characteristic of the soil are analyzed by comparing the characteristic spectrum with a soil spectrum obtained from a soil having a new characteristic.

### CITATION LIST

### Patent Literature

PTL 1: JP 2006-038511A

### SUMMARY

### Technical Problem

It is very difficult to design and manufacture an optical filter for separately receiving light of a plurality of types of wavelengths in a spectroscopic sensor, and a variation in spectral sensitivity (hereinafter, described as a “spectral sensitivity variation”) occurs for each wavelength due to individual differences for each spectroscopic sensor. In PTL 1, the same spectroscopic sensor is used at any time in the soil analysis method, so that it is not necessary to consider spectral sensitivity variation due to individual differences.

However, it is difficult to efficiently perform the analysis work due to the restriction of using the same spectroscopic sensor at any time.

The present technology has been made in view of the above problems, and an object thereof is to provide an environment in which a sensor output of a spectroscopic sensor can be handled without considering a variation in spectral sensitivity of the spectroscopic sensor.

### Solution to Problem

An information processing device according to the present technology includes a coefficient calculation unit configured to calculate a coefficient included in a conversion algorithm for converting first sensor output into different output, the first sensor output being spectral information output by a first spectroscopic sensor, wherein the coefficient calculation unit calculate the coefficient so that the different output obtained by inputting the first sensor output to the conversion algorithm approaches second sensor output, the second sensor output being spectral information output by a second spectroscopic sensor different from the first spectroscopic sensor.

As described above, it is difficult for the spectroscopic sensor to have a uniform wavelength characteristic due to the high manufacturing difficulty level. According to the present configuration, the coefficient of the conversion algorithm used to absorb the difference in wavelength characteristics between the first spectroscopic sensor and the second spectroscopic sensor, in other words, to bring the wavelength characteristic indicated by the output of the first spectroscopic sensor close to the wavelength characteristic indicated by the output of the second spectroscopic sensor is calculated.

Furthermore, an information processing device according to the present technology includes a conversion processing unit configured to input first sensor output, the first sensor output being spectral information output by a first spectroscopic sensor, to a conversion algorithm to convert the first sensor output into output different from the first sensor output, wherein a coefficient included in the conversion algorithm is a coefficient calculated so that the different output obtained by inputting the first sensor output to the conversion algorithm approaches second sensor output, the second sensor output being spectral information output by a second spectroscopic sensor different from the first spectroscopic sensor.

As a result, the first sensor output can be treated as output corresponding to the second sensor output using a conversion algorithm to which a coefficient for absorbing a difference in wavelength characteristics between the first spectroscopic sensor and the second spectroscopic sensor is applied.

Furthermore, an image processing device according to the present technology includes a storage unit that stores a spectroscopy application that performs a predetermined process with second sensor output as input, the second sensor output being spectral information output by a second spectroscopic sensor different from a first spectroscopic sensor, and an application processing unit configured to input the second sensor output to the spectroscopy application to obtain a processing result of the predetermined process, wherein the spectroscopy application is optimized so as to obtain predetermined performance in a case where converted output obtained by applying predetermined conversion to first sensor output, the first sensor output being spectral information output by the first spectroscopic sensor, is used as input data, and wherein the predetermined conversion is conversion using a conversion algorithm that brings the converted output close to the second sensor output.

As a result, a spectroscopy application optimized to obtain predetermined performance when data corresponding to the second sensor output obtained by converting the first sensor output using the conversion algorithm to which the coefficient for absorbing the difference in wavelength characteristics between the first spectroscopic sensor and the second spectroscopic sensor is applied is input is generated. That is, the sensor output of the second spectroscopic sensor is unnecessary for generating the spectroscopy application.

### BRIEF DESCRIPTION OF DRAWINGS

FIG. 1 is a block diagram illustrating a schematic configuration example of a spectroscopic camera used in the embodiment.

FIG. 2 is a diagram schematically illustrating a configuration example of a pixel array unit included in a spectroscopic sensor.

FIG. 3 is an explanatory diagram of a narrowbanding process according to the first embodiment.

FIG. 4 is a diagram illustrating a configuration example of an algorithm derivation system including a coefficient calculation device according to the first embodiment.

FIG. 5 is a block diagram illustrating a schematic configuration example of the coefficient calculation device according to the first embodiment.

FIG. 6 is a functional block diagram illustrating each function of algorithm derivation included in the coefficient calculation device according to the first embodiment.

FIG. 7 is a block diagram illustrating a schematic configuration example of a spectroscopy application generation device according to the first embodiment.

FIG. 8 is a functional block diagram illustrating each function of generating a spectroscopy application included in the spectroscopy application generation device according to the first embodiment.

FIG. 9 is a block diagram illustrating a configuration and a function of analysis processing indicated by an analysis device according to the first embodiment.

FIG. 10 is a flowchart illustrating an example of a process performed by the coefficient calculation device according to the first embodiment.

FIG. 11 is a flowchart illustrating an example of a process performed by the spectroscopy application generation device according to the first embodiment.

FIG. 12 is a flowchart illustrating an example of a process performed by the analysis device according to the first embodiment.

FIG. 13 is a diagram schematically illustrating a relationship between devices according to the first embodiment.

FIG. 14 is a diagram illustrating a configuration example of an algorithm derivation system according to the second embodiment.

FIG. 15 is a diagram illustrating an example of subject spectral reflectance information.

FIG. 16 is a functional block diagram illustrating each function of algorithm derivation included in a coefficient calculation device as the second embodiment.

FIG. 17 is a flowchart illustrating an example of a process performed by the coefficient calculation device according to the second embodiment.

FIG. 18 is a block diagram illustrating a schematic configuration example of a spectroscopy application generation device according to the third embodiment.

FIG. 19 is a functional block diagram illustrating each function of generating a spectroscopy application included in the spectroscopy application generation device according to the third embodiment.

FIG. 20 is a block diagram illustrating a configuration and a function of analysis processing indicated by the analysis device according to the third embodiment.

FIG. 21 is a flowchart illustrating an example of a process performed by the spectroscopy application generation device according to the third embodiment.

FIG. 22 is a flowchart illustrating an example of a process performed by the analysis device according to the third embodiment.

FIG. 23 is a diagram schematically illustrating a relationship between devices according to the third embodiment.

FIG. 24 is a diagram illustrating a configuration example of an algorithm derivation system according to the fourth embodiment.

FIG. 25 is a block diagram illustrating a schematic configuration example of a coefficient calculation device according to the fourth embodiment.

FIG. 26 is a functional block diagram illustrating each function of algorithm derivation included in the coefficient calculation device according to the fourth embodiment.

FIG. 27 is a flowchart illustrating an example of a process performed by the coefficient calculation device according to the fourth embodiment.

FIG. 28 is an explanatory diagram of divided regions obtained by dividing the light receiving face of the spectroscopic sensor according to the fifth embodiment.

FIG. 29 is a diagram illustrating a configuration example of an algorithm derivation system according to the fifth embodiment.

FIG. 30 is a block diagram illustrating a schematic configuration example of a coefficient calculation device according to the fifth embodiment.

FIG. 31 is a functional block diagram illustrating each function of algorithm derivation included in the coefficient calculation device according to the fifth embodiment.

FIG. 32 is a diagram illustrating another configuration example of the algorithm derivation system according to the fifth embodiment.

FIG. 33 is a flowchart illustrating an example of a process performed by the coefficient calculation device according to the fifth embodiment.

FIG. 34 is a block diagram of a computer-based system on which embodiments of the present system may be implemented.

### DESCRIPTION OF EMBODIMENTS

Hereinafter, embodiments according to the present technology will be described in the following order with reference to the accompanying drawings.
<1. Spectroscopic camera>
<2. First Embodiment>
<2-1. Configuration of algorithm derivation system>
<2-2. Configuration of coefficient calculation device>
<2-3. Calculation of post-adjustment narrowbanding coefficient>
<2-4. Configuration of spectroscopy application generation device>
<2-5. Configuration of analysis device>
<2-6. Processing flow>
<2-6-1. Coefficient calculation device>
<2-6-2. Spectroscopy application generation device>
<2-6-3. Analysis device>
<2.-7. Relationship between devices>
<3. Second Embodiment>
<3-1. Configuration of algorithm derivation system>
<3-2. Processing flow>
<4. Third Embodiment>
<4-1. Configuration of spectroscopy application generation device>
<4-2. Configuration of analysis device>
<4-3. Processing flow>
<4-3-1. Spectroscopy application generation device>
<4-3-2. Analysis device>
<4.-4. Relationship between devices>
<5. Fourth Embodiment>
<6. Fifth Embodiment>
<7. Modifications>
<8. Notes>
<9. Summary>
<10. Present technology>

### 1. SPECTROSCOPIC CAMERA

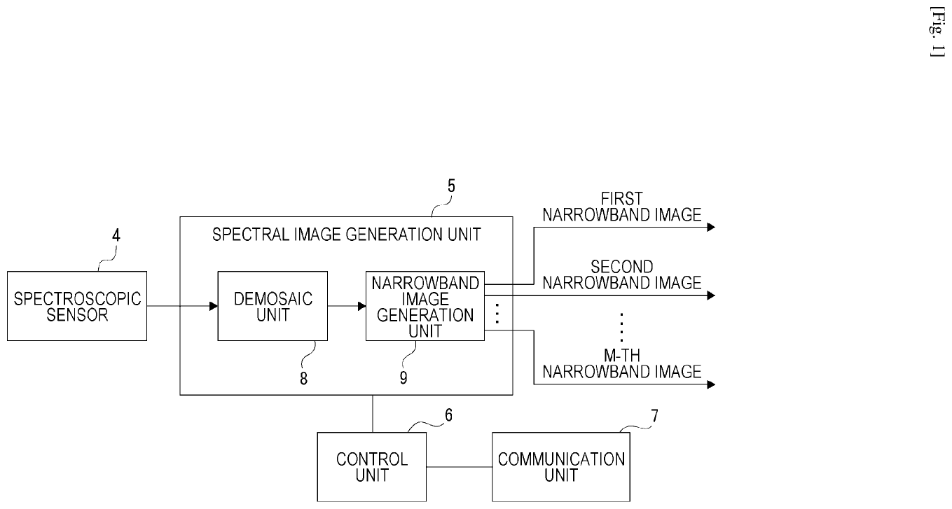

First, an example of a spectroscopic camera used in the present technology will be described with reference to FIGS. 1 to 3.

FIG. 1 is a block diagram illustrating a schematic configuration example of a spectroscopic camera 3 used in each embodiment.

Here, the “spectroscopic camera” means a camera including a spectroscopic sensor as a light receiving sensor. The “spectroscopic sensor” is a light receiving sensor for obtaining a plurality of narrowband images (an M-th narrowband image from a first narrowband image in the drawing) as an image expressing the wavelength characteristic of light from a subject.

Note that, in the following description, an image in which wavelength characteristic are expressed is referred to as a narrowband image, but the narrowband image can also be regarded as spectral information for each channel after narrowbanding. That is, the narrowband image is not necessarily expressed in an image format.

As illustrated, a spectroscopic camera 3 includes a spectroscopic sensor 4, a spectral image generation unit 5, a control unit 6, and a communication unit 7.

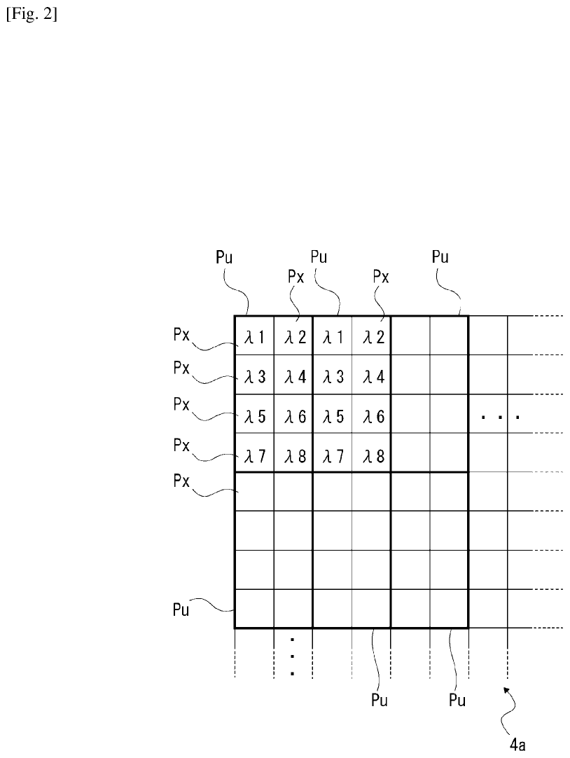

FIG. 2 is a diagram schematically illustrating a configuration example of a pixel array unit 4a included in the spectroscopic sensor 4.

As illustrated, the pixel array unit 4a has a spectral pixel unit Pu in which a plurality of pixels Px receiving light of different wavelength bands is two-dimensionally disposed in a predetermined pattern. The pixel array unit 4a includes a plurality of spectral pixel units Pu disposed two-dimensionally.

In the example illustrated in FIG. 2, an example in which each of the spectral pixel units Pu individually receives light of a total of eight wavelength bands of λ1 to λ8 in the respective pixels Px, in other words, an example in which the number of wavelength bands to be received in each of the spectral pixel units Pu (hereinafter referred to as “number of light receiving wavelength channels”) is “8” is illustrated, but this is merely an example for description, and the number of light receiving wavelength channels in the spectral pixel unit Pu may be at least plural, and can be any number.

In the following description, the number of light receiving wavelength channels in the spectral pixel unit Pu is referred to as “N”.

In FIG. 1, the spectral image generation unit 5 generates M narrowband images on the basis of a RAW image as an image output from the spectroscopic sensor 4. Here, “M>N”, and for example, M=41 with respect to N=8.

The spectral image generation unit 5 includes a demosaic unit 8 and a narrowband image generation unit 9.

The demosaic unit 8 performs a demosaic process on the RAW image from the spectroscopic sensor 4.

The narrowband image generation unit 9 performs a narrowbanding process (linear matrix processing) bases on the N-channel wavelength band images obtained by the demosaic process, thereby generating M narrowband images from the N wavelength band images.

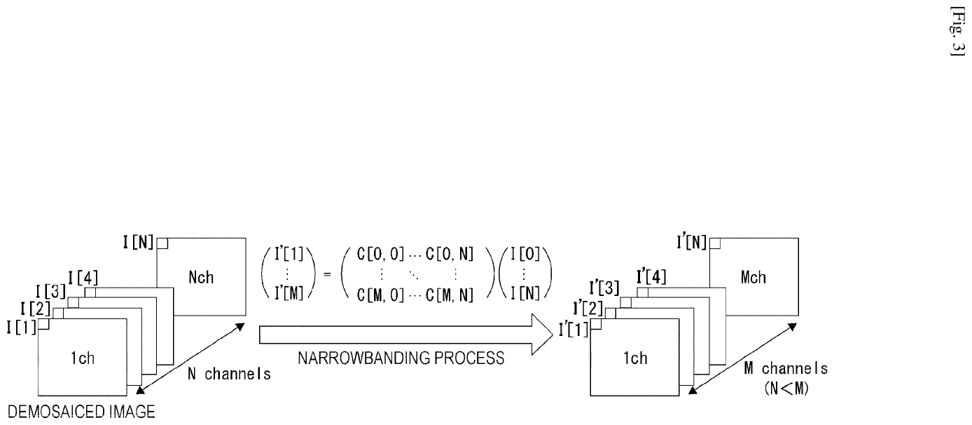

FIG. 3 is an explanatory diagram of a narrowbanding process for obtaining M narrowband images.

On the basis of the wavelength band images for N channels obtained by the demosaic process by the demosaic unit 8, for example, matrix operation as illustrated is performed for each pixel position to obtain narrowband images for M channels. In order to convert the wavelength band images for N channels into narrowband images for M channels in this manner, the process of obtaining pixel values (in the figure, I′[1] to I′[m]) for M channels by matrix operation using the pixel values (in the figure, I[1] to I[n]) for N channels for each pixel position is a narrowbanding process.

The arithmetic expression of the narrowbanding process can be expressed by the following [Expression 1], where R is a pixel value after the demosaicing process, n is an input wavelength channel (an integer from 1 to N), C is a narrowbanding coefficient, B is a pixel value output by the narrowbanding process, and m is an output wavelength channel (an integer from 1 to M).

$$[ Math . 1 ]$$

$$B [ m ] = {\sum }_{n = 1}^{N} ( R [ n ] * C [ m , n ] ) \qquad [ Expression 1 ]$$

That is, when m=1, the output wavelength channel pixel value B [1]=R[1]×C[1, 1]+R[2]×C[1,2]+R[3]×C[1,3]+ . . . +R[N]×C[1, N]. In addition, when m=2, the output wavelength channel pixel value B [2]=R[1]×C[2, 1]+R[2]×C[2,2]+R[3]×C[2, 3]+ . . . +R[N]×C[2, N].

Thereafter, similarly, when m=M, the output wavelength channel pixel value B [M]=R[1]×C[M, 1]+R[2]×C[M, 2]+R[3]×C[M, 3]+ . . . +R[N]×C[M, N].

At this time, the N narrowbanding coefficients C, from C[m, 1] to C[m, N] are used for each of the pixel values B [1] to B [M]. That is, the total (N×M) narrowbanding coefficients C are used.

Note that the narrowbanding coefficient C can be rephrased as a coefficient matrix C including N rows and M columns. Note that, here, the element in the first row and the first column, which are the upper left elements in the matrix, is C[1, 1].

In FIG. 1, the control unit 6 includes a microcomputer including, for example, a central processing unit (CPU), a read only memory (ROM), a random access memory (RAM), and the like, and performs overall control of the spectroscopic camera 3 by the CPU executing processing bases on, for example, a program stored in the ROM or a program loaded in the RAM.

The communication unit 7 performs wired or wireless data communication with an external device. For example, the communication unit 7 may be configured to perform wired data communication with an external device according to a predetermined wired communication standard such as a Universal Serial Bus (USB) communication standard, wireless data communication with an external device according to a predetermined wireless communication standard such as a Bluetooth (registered trademark) communication standard, or wireless or wired data communication with an external device via a predetermined network such as the Internet.

The control unit 6 can transmit and receive data to and from an external device via the communication unit 7.

### 2. FIRST EMBODIMENT

A first embodiment of an information processing device according to the present technology will be described with reference to the accompanying drawings.

### <2-1. Configuration of Algorithm Derivation System>

An algorithm derivation system Sys is a system that derives an algorithm for absorbing the different wavelength characteristics for respective spectroscopic sensors 4. For example, the algorithm derivation system Sys derives a conversion algorithm for converting the output of a certain spectroscopic sensor 4 into output corresponding to the output of a different spectroscopic sensor 4.

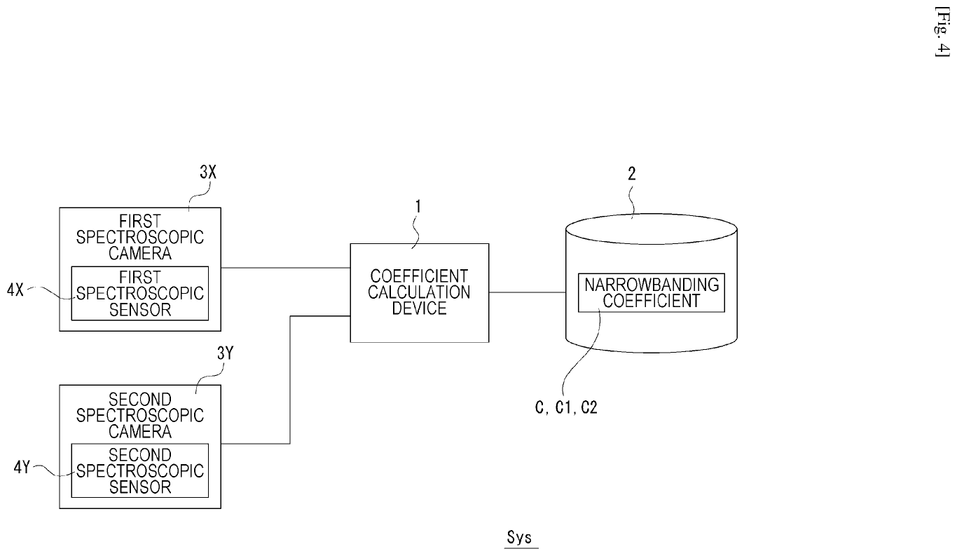

FIG. 4 is a diagram illustrating a configuration example of an algorithm derivation system Sys including a coefficient calculation device 1 to which the information processing device according to the present technology is applied.

The algorithm derivation system Sys includes a plurality of spectroscopic cameras 3, the coefficient calculation device 1, and a database 2.

The algorithm derivation system Sys according to the present embodiment includes a first spectroscopic camera 3X and a second spectroscopic camera 3Y as the plurality of spectroscopic cameras 3.

The spectroscopic sensor 4 included in the first spectroscopic camera 3X is referred to as a first spectroscopic sensor 4X, and the spectroscopic sensor 4 included in the second spectroscopic camera 3Y is referred to as a second spectroscopic sensor 4Y.

The coefficient calculation device 1 generates narrowband images for M channels from the wavelength band images for N channels for both the first spectroscopic sensor 4X and the second spectroscopic sensor 4Y using the narrowbanding coefficient C stored in the database 2.

Note that the narrowband image for the first spectroscopic sensor 4X and the narrowband image for the second spectroscopic sensor 4Y generated here are different images due to the different wavelength characteristics of the spectroscopic sensor 4.

The coefficient calculation device 1 adjusts respective elements of the narrowbanding coefficient C (coefficient matrix C) to substantially match the narrowband image for the first spectroscopic sensor 4X with the narrowband image for the second spectroscopic sensor 4Y.

Here, a narrowbanding coefficient C before adjustment is referred to as a “pre-adjustment narrowbanding coefficient C1”, and a narrowbanding coefficient C after adjustment is referred to as a “post-adjustment narrowbanding coefficient C2”.

The post-adjustment narrowbanding coefficient C2 can be said to be a coefficient used in a conversion algorithm for converting the first sensor output OP1 that is wavelength band images for N channels in the first spectroscopic sensor 4X into narrowband images for M channels for the second spectroscopic sensor 4Y.

Here, converting the first sensor output OP1 for N channels into narrowband images for M channels for the second spectroscopic sensor 4Y will be described as “converting the output of the first spectroscopic sensor 4X into output corresponding to the output of the second spectroscopic sensor 4Y”.

The coefficient calculation device 1 stores the calculated post-adjustment narrowbanding coefficient C2 in the database 2 and supplies the coefficient to the first spectroscopic camera 3X as appropriate.

Note that it may not be required for the coefficient calculation device 1 itself to transmit the post-adjustment narrowbanding coefficient C2 used in the conversion algorithm derived by the coefficient calculation device 1 to the first spectroscopic camera 3X. For example, it is conceivable that the post-adjustment narrowbanding coefficient C2 derived by the coefficient calculation device 1 is stored on a cloud, and the first spectroscopic camera 3X may acquire the post-adjustment narrowbanding coefficient C2 from the cloud.

Note that converting the output of the first spectroscopic sensor 4X into output corresponding to the output of the second spectroscopic sensor 4Y is suitable, for example, for creating a spectroscopy application AP optimized for the wavelength characteristic of the second spectroscopic sensor 4Y.

Here, the spectroscopy application AP is an application that performs subject analysis on the basis of the narrowband image obtained by the spectroscopic camera 3. For example, an application for analyzing a growth state of vegetables in the agricultural field and an application for analyzing a health condition of a patient in the medical field correspond to the spectroscopy application AP.

In a case where the spectroscopy application AP is adjusted to exhibit high performance in a case where the narrowband image output from the second spectroscopic sensor 4Y is input, it is preferable to use the narrowband image output from the second spectroscopic sensor 4Y.

However, in some cases, the second spectroscopic sensor 4Y may not be used freely.

In such a case, by adjusting the spectroscopy application AP using the narrowband image obtained by converting the output of the first spectroscopic sensor 4X into output corresponding to the output of the second spectroscopic sensor 4Y, it is possible to obtain the spectroscopy application AP optimized for the second spectroscopic sensor 4Y.

In addition, it is possible to shorten the time for obtaining the narrowband image necessary for adjustment of the spectroscopy application AP by preparing a plurality of the first spectroscopic sensors 4X and the other spectroscopic sensors 4 that can convert the output to output corresponding to the output of the second spectroscopic sensor 4Y rather than using one second spectroscopic sensor 4Y.

### <2-2. Configuration of Coefficient Calculation Device>

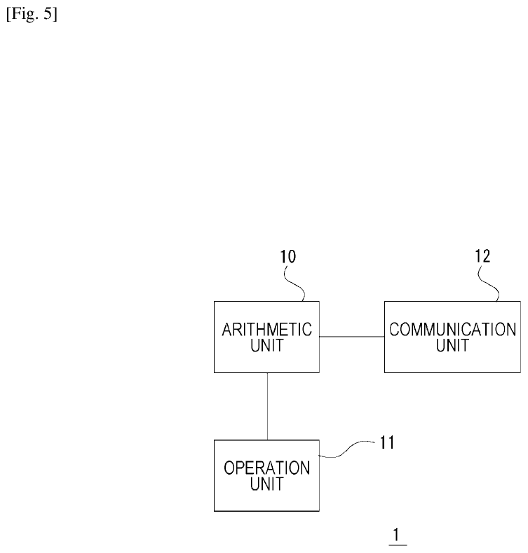

FIG. 5 is a block diagram illustrating a schematic configuration example of the coefficient calculation device 1.

As illustrated, the coefficient calculation device 1 includes an arithmetic unit 10, an operation unit 11, and a communication unit 12.

The arithmetic unit 10 includes, for example, a microcomputer including a CPU, a ROM, a RAM, and the like, and performs predetermined calculation and overall control of the coefficient calculation device 1 by the CPU executing a process bases on a program stored in the ROM or a program loaded in the RAM.

The operation unit 11 includes various operators such as a keyboard, a mouse, a key, a dial, a touch panel, and a touch pad for the user to perform an operation input to the coefficient calculation device 1 to output an operation signal corresponding to an operation on the operator to the arithmetic unit 10.

The arithmetic unit 10 performs a process according to the operation signal. As a result, the process of the coefficient calculation device 1 according to the user operation is realized.

The communication unit 12 performs wired or wireless data communication with an external device (particularly, the database 2 or the spectroscopic camera 3 illustrated in FIG. 4 in this example). As in the communication unit 7 described above, the communication unit 12 may be configured to perform wired data communication with an external device according to a predetermined wired communication standard such as a USB communication standard, wireless data communication with an external device according to a predetermined wireless communication standard such as a Bluetooth communication standard, or wireless or wired data communication with an external device via a predetermined network such as the Internet.

The arithmetic unit 10 can transmit and receive data to and from an external device via the communication unit 12.

### <2-3. Calculation of Post-Adjustment Narrowbanding Coefficient>

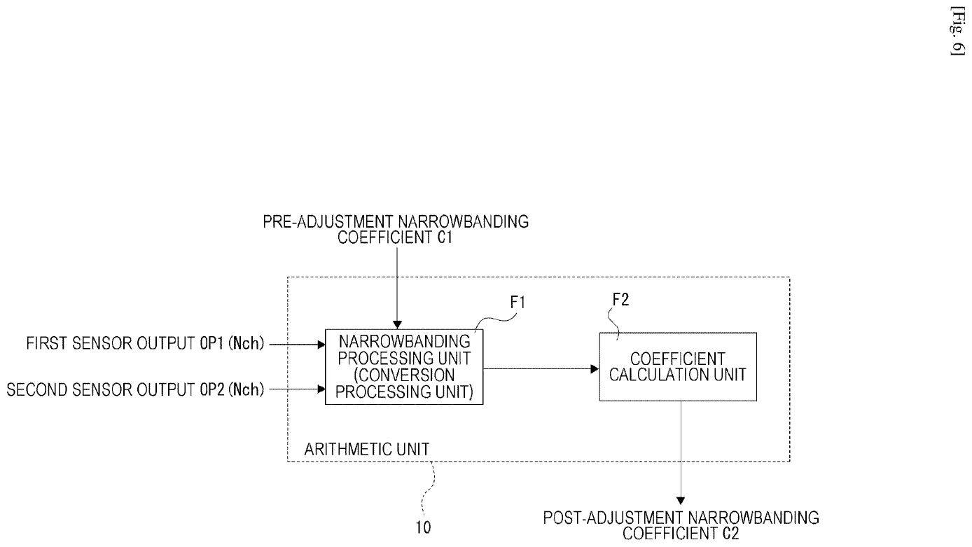

A configuration of the coefficient calculation device 1 for calculating the post-adjustment narrowbanding coefficient C2 will be described with reference to FIG. 6.

The arithmetic unit 10 of the coefficient calculation device 1 includes a narrowbanding processing unit F1 and a coefficient calculation unit F2 in order to calculate the post-adjustment narrowbanding coefficient C2.

The narrowbanding processing unit F1 generates narrowband images for M channels using the first sensor output OP1 for N channels and the pre-adjustment narrowbanding coefficient C1.

In addition, the narrowbanding processing unit F1 generates narrowband images for M channels using the second sensor outputs OP2 for N channels and the pre-adjustment narrowbanding coefficient C1.

Note that the first sensor output OP1 and the second sensor output OP2 are spectral information obtained from the respective spectroscopic sensors 4 with the same type of a subject and a light source.

Therefore, if there is no difference in spectral sensitivity between the first spectroscopic sensor 4X and the second spectroscopic sensor 4Y, the first sensor output OP1 and the second sensor output OP2 have the same output, and the images for respective wavelengths narrowbanded using the pre-adjustment narrowbanding coefficient C1 are also the same.

However, since there is actually a difference in spectral sensitivity between the first spectroscopic sensor 4X and the second spectroscopic sensor 4Y, a difference also occurs in the narrowband image calculated using the pre-adjustment narrowbanding coefficient C1.

The coefficient calculation unit F2 calculates the post-adjustment narrowbanding coefficient C2 for absorbing a difference between the narrowband image obtained for the first spectroscopic sensor 4X and the narrowband image obtained for the second spectroscopic sensor 4Y. That is, it can be said that the coefficient calculation unit F2 calculates a coefficient included in a conversion algorithm for converting the output of the first spectroscopic sensor 4X into output corresponding to the output of the second spectroscopic sensor 4Y.

Various methods can be considered as a method of calculating the post-adjustment narrowbanding coefficient C2.

For example, a plurality of candidates for the post-adjustment narrowbanding coefficient C2 is prepared, and the narrowbanding processing unit F1 selects one post-adjustment narrowbanding coefficient C2 from the prepared candidates and applies the coefficient to the first sensor output OP1 to generate narrowband images for M channels.

On the other hand, the narrowbanding processing unit F1 performs a narrowbanding process on the second sensor output OP2 using the pre-adjustment narrowbanding coefficient C1.

The coefficient calculation unit F2 compares the narrowband image for the first spectroscopic sensor 4X and the narrowband image for the second spectroscopic sensor 4Y obtained in this manner, and evaluates the difference.

Such processing is repeated while changing the post-adjustment narrowbanding coefficient C2 to be selected.

The post-adjustment narrowbanding coefficient C2 having the minimum difference evaluated is finally determined as a variable of the conversion algorithm.

In other than to this, it is also conceivable that the derivation process of the coefficient (post-adjustment narrowbanding coefficient C2) included in the conversion algorithm for converting the output of the first spectroscopic sensor 4X into the output of the second spectroscopic sensor 4Y is performed as a process using the least squares method, for example, a process using a regression analysis algorithm such as Ridge regression or Lasso regression.

Note that derivation of the coefficient included in a conversion algorithm having a function of converting the output of the first spectroscopic sensor 4X into output corresponding to the output of the second spectroscopic sensor 4Y may be performed using a technique of artificial intelligence (AI). Specifically, an AI model that outputs narrowband images for M channels for the second spectroscopic sensor 4Y in a case where wavelength band images for N channels for the first spectroscopic sensor 4X are input is generated by machine training.

Note that the AI model described here is described as an “output conversion AI model M1” in order to be distinguished from the AI model referred to in the following description.

As the teacher data used for training the output conversion AI model M1, for example, wavelength band images for N channels obtained from the first spectroscopic sensor 4X are set as input data, and narrowband images for M channels for the second spectroscopic sensor 4Y are set as correct answer data.

It is possible to train the output conversion AI model M1 by preparing such teacher data using various subjects and light sources.

Then, the output conversion AI model M1 calculated in this case can be said to be the conversion algorithm itself described above, and the weight coefficient included in the output conversion AI model M1 can be said to be a coefficient included in the conversion algorithm.

That is, it can be said that the coefficient calculation unit F2 calculates the coefficient included in the conversion algorithm by calculating the weight coefficient included in the output conversion AI model M1.

In addition, it can be said that the post-adjustment narrowbanding coefficient C2 calculated here is calculated on the basis of the wavelength characteristics of the first spectroscopic sensor 4X and the second spectroscopic sensor 4Y. In other words, it can be said that the coefficient calculation unit F2 calculates the coefficient using the wavelength characteristics of the wavelength characteristic of the first spectroscopic sensor 4X and the wavelength characteristic of the second spectroscopic sensor 4Y.

### <2-4. Configuration of Spectroscopy Application Generation Device>

A conversion algorithm for converting the output of the first spectroscopic sensor 4X into output corresponding to the output of the second spectroscopic sensor 4Y is used, for example, for generating (or adjusting) the spectroscopy application AP.

As described above, the spectroscopy application AP is an application that performs subject analysis on the basis of the narrowband image obtained by the spectroscopic camera 3, and corresponds to an application for analyzing the growth state of vegetables and an application for analyzing the health condition of a patient.

Note that, here, as an example of the spectroscopy application AP, a spectroscopy application AP that performs an inference process using an AI model will be described as an example. The AI model used in the spectroscopy application AP is referred to as a “subject analysis AI model M2”.

In order to optimize the spectroscopy application AP for the second spectroscopic sensor 4Y, it is desirable to use a narrowband image obtained from the second spectroscopic sensor 4Y for training the subject analysis AI model M2 or a narrowband image equivalent thereto. The trained subject analysis AI model M2 obtained as a result can output an inference result with high inference accuracy by inputting the narrowband image obtained on the basis of the second sensor output OP2 from the second spectroscopic sensor 4Y.

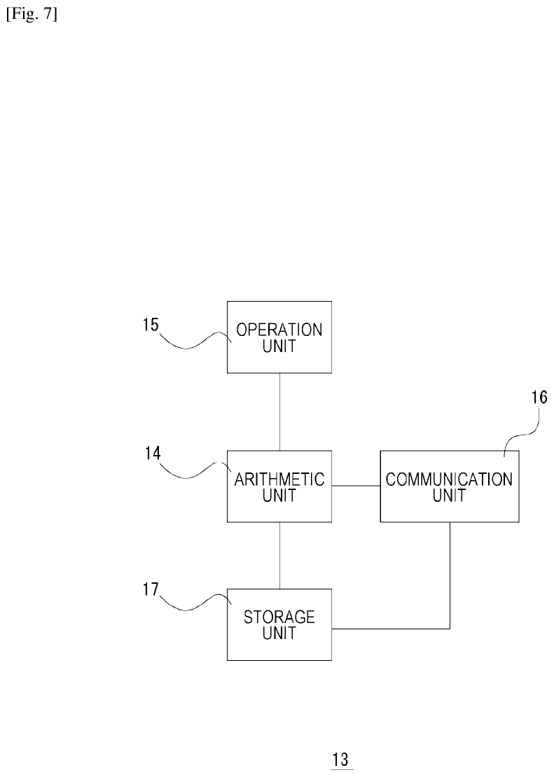

A configuration example of a spectroscopy application generation device 13 that generates (adjusts) such a spectroscopy application AP is illustrated in FIG. 7.

The spectroscopy application generation device 13 includes an arithmetic unit 14, an operation unit 15, a communication unit 16, and a storage unit 17.

The arithmetic unit 14 includes, for example, a microcomputer including a CPU, a ROM, a RAM, and the like, and performs predetermined calculation and overall control of the spectroscopy application generation device 13 by the CPU executing a process bases on a program stored in the ROM or a program loaded in the RAM.

The operation unit 11 includes various operators such as a keyboard, a mouse, a key, a dial, a touch panel, and a touch pad for the user to perform an operation input to the spectroscopy application generation device 13 to output an operation signal corresponding to an operation on the operator to the arithmetic unit 14.

The arithmetic unit 14 performs a process according to the operation signal. As a result, the process of the spectroscopy application generation device 13 according to the user operation is realized.

The communication unit 16 performs wired or wireless data communication with an external device (for example, the coefficient calculation device 1). As in the communication unit 7 described above, the communication unit 16 may be configured to perform wired data communication with an external device according to a predetermined wired communication standard such as a USB communication standard, wireless data communication with an external device according to a predetermined wireless communication standard such as a Bluetooth communication standard, or wireless or wired data communication with an external device via a predetermined network such as the Internet.

The arithmetic unit 14 can transmit and receive data to and from an external device via the communication unit 16.

The storage unit 17 comprehensively represents various ROMs, RAMs, and the like, and programs executed by the arithmetic unit 14 and various pieces of data used for arithmetic processing are stored in the storage unit 17.

The storage unit 17 stores the post-adjustment narrowbanding coefficient C2 calculated by the coefficient calculation device 1.

When the arithmetic unit 14 executes the program, the spectroscopy application generation device 13 has a function of generating the spectroscopy application AP.

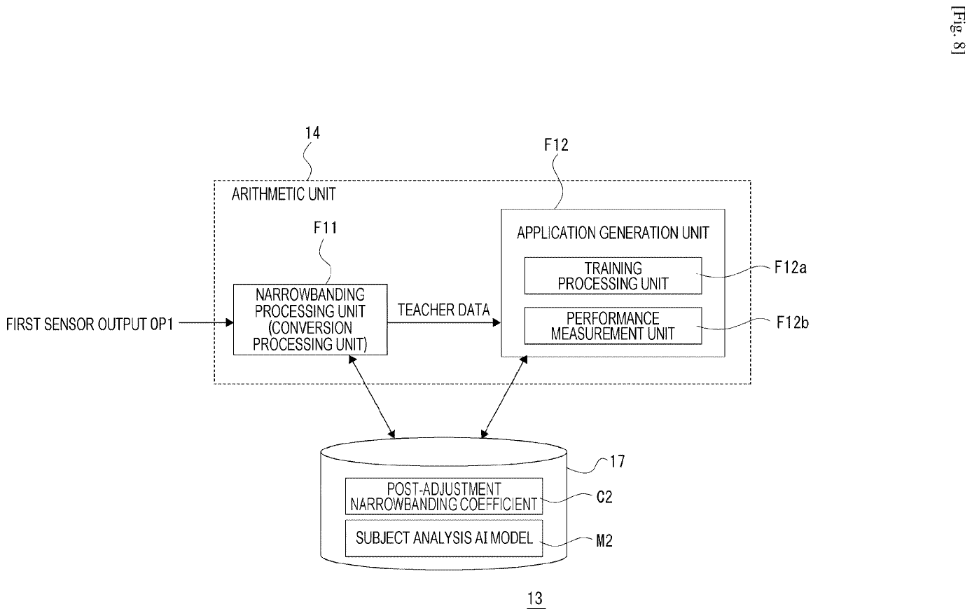

A configuration of the spectroscopy application generation device 13 for this purpose is illustrated in FIG. 8.

The arithmetic unit 14 of the spectroscopy application generation device 13 includes a narrowbanding processing unit F11 and an application generation unit F12.

The narrowbanding processing unit F11 performs a matrix operation using the first sensor output OP1 for N channels output from the first spectroscopic sensor 4X and the post-adjustment narrowbanding coefficient C2 acquired from the storage unit 17, and generates narrowband images for M channels. It can also be said that this process is a narrowbanding process and a process of applying a conversion algorithm. That is, the narrowbanding processing unit F11 can be said to be a conversion processing unit configured to convert the output of the first spectroscopic sensor 4X into output corresponding to the output of the second spectroscopic sensor 4Y.

The narrowband image generated by the narrowbanding processing unit F11 is provided to the application generation unit F12 as teacher data.

The application generation unit F12 further includes a training processing unit F12a and a performance measurement unit F12b.

The training processing unit F12a performs machine training using the teacher data supplied from the narrowbanding processing unit F11 and trains the subject analysis AI model M2.

The performance measurement unit F12b measures the performance of the trained subject analysis AI model M2 generated by the training processing unit F12a. As a result, the performance measurement unit F12b determines whether or not the generated subject analysis AI model M2 has desired performance.

By repeatedly performing the processing by the training processing unit F12a and the performance measurement unit F12b, the application generation unit F12 generates the trained subject analysis AI model M2 satisfying desired performance. The application generation unit F12 stores the generated subject analysis AI model M2 in the storage unit 17.

### <2-5. Configuration of Analysis Device>

An analysis device 18 is a device that analyzes the subject using the second sensor output OP2 that is output from the second spectroscopic sensor 4Y and the trained subject analysis AI model M2.

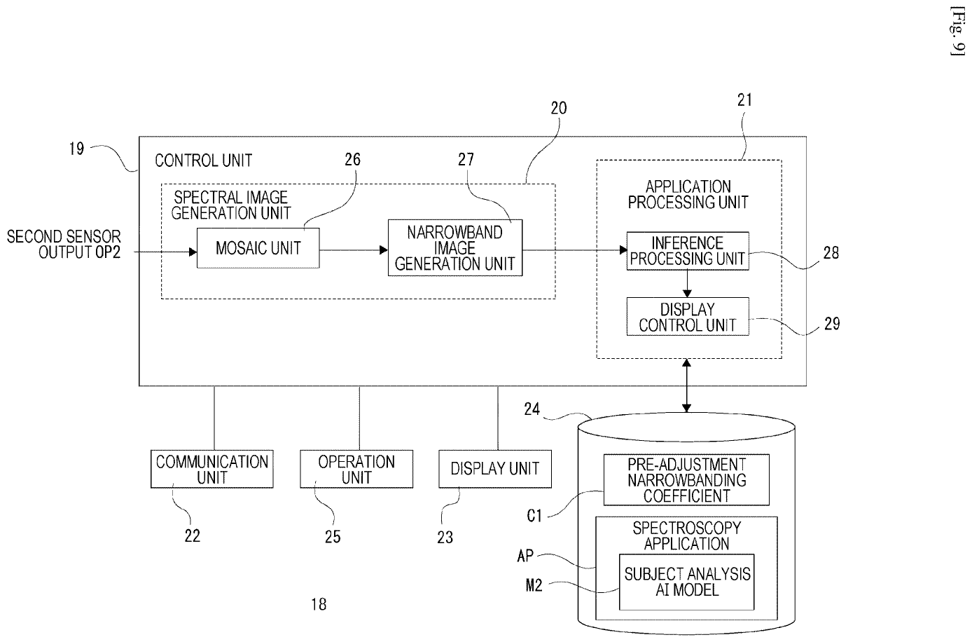

As illustrated in FIG. 9, the analysis device 18 includes a control unit 19.

The control unit 19 includes, for example, a microcomputer including a CPU, a ROM, a RAM, and the like, and performs overall control of the analysis device 18 by the CPU executing a process bases on, for example, a program stored in the ROM or a program loaded in the RAM.

In addition, the control unit 19 functions as a spectral image generation unit 20 and an application processing unit 21 by executing various programs.

The analysis device 18 further includes a communication unit 22, a display unit 23, a storage unit 24, and an operation unit 25.

The spectral image generation unit 20 has the same configuration as the spectral image generation unit 5 illustrated in FIG. 1, and includes a demosaic unit 26 and a narrowband image generation unit 27.

The demosaic unit 26 performs a demosaic process on the second sensor output OP2 that is RAW images for N channels from the second spectroscopic sensor 4Y.

The narrowband image generation unit 27 generates narrowband images for M channels by performing a narrowbanding process using the respective wavelength band images for N channels obtained by the demosaic process and the pre-adjustment narrowbanding coefficient C1.

Accordingly, the pre-adjustment narrowbanding coefficient C1 is stored in the storage unit 24.

The application processing unit 21 activates the spectroscopy application AP and performs various processes, thereby realizing processing according to an instruction by the user who uses the spectroscopy application AP.

Specifically, the application processing unit 21 includes an inference processing unit 28 and a display control unit 29 in order to realize a predetermined function.

The inference processing unit 28 performs an inference process using the narrowband image as input data to output an inference result and likelihood information.

The display control unit 29 performs a process of presenting likelihood information to the user.

Furthermore, the application processing unit 21 can perform setting processing and the like according to a user's instruction.

The communication unit 22 performs wired or wireless data communication with an external device (for example, the second spectroscopic camera 3Y). As in the communication unit 7 described above, the communication unit 22 may be configured to perform wired data communication with an external device according to a predetermined wired communication standard such as a USB communication standard, wireless data communication with an external device according to a predetermined wireless communication standard such as a Bluetooth communication standard, or wireless or wired data communication with an external device via a predetermined network such as the Internet.

The control unit 19 can transmit and receive data to and from an external device via the communication unit 22.

The display unit 23 is a monitor such as a liquid crystal display (LCD) or an organic electro-luminescence (EL) panel, and displays a wavelength band image or a narrowband spectral image or displays an inference result and likelihood information thereof under the control of the display control unit 29.

The storage unit 24 stores a program as a spectroscopy application AP which is an application for realizing the functions of the inference processing unit 28 and the display control unit 29.

In addition, the subject analysis AI model M2 is included in the program of the spectroscopy application AP.

The operation unit 25 includes various operators such as a keyboard, a mouse, a key, a dial, a touch panel, and a touch pad for the user to perform an operation input to the analysis device 18 to output an operation signal corresponding to an operation on the operator to the control unit 19.

The control unit 19 performs a process according to the operation signal. As a result, the process of the analysis device 18 according to the user operation is realized.

Note that, in the present example, the example in which the spectroscopy application AP and the subject analysis AI model M2 are stored in the storage unit 24 is described, but the present disclosure is not limited thereto, and the spectroscopy application AP and the subject analysis AI model M2 may be stored in the server device. In this case, the analysis device 18 receives the analysis result and the likelihood information from the server device by using the spectroscopy application AP as a cloud application and the subject analysis AI model M2.

Furthermore, the process for display may be implemented in the server device. That is, the user may check the analysis result or the like in the spectroscopy application AP by causing the display unit 23 to display display data such as a web page generated by the server device.

### <2-6. Processing Flow>

An example of a process performed by each device in the present embodiment will be described.

### <2-6-1. Coefficient Calculation Device>

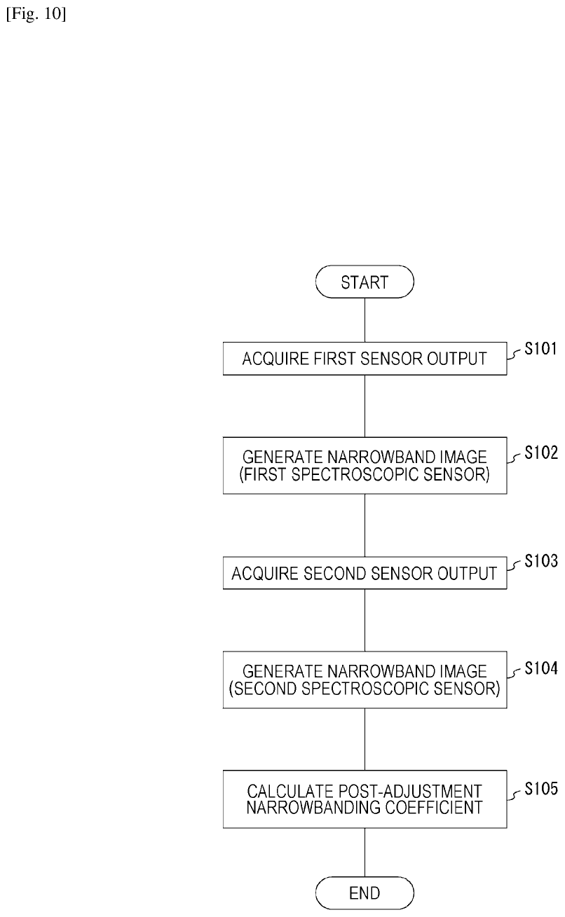

FIG. 10 illustrates an example of a process performed by the coefficient calculation device 1 to calculate the post-adjustment narrowbanding coefficient C2.

In step S101 of FIG. 10, the arithmetic unit 10 of the coefficient calculation device 1 acquires the first sensor output OP1 from the first spectroscopic sensor 4X.

In step S102, the arithmetic unit 10 generates a narrowband image for the first spectroscopic sensor 4X. The narrowbanding coefficient C used at this time is a pre-adjustment narrowbanding coefficient C1.

In step S103, the arithmetic unit 10 acquires the second sensor output OP2 from the second spectroscopic sensor 4Y.

In step S104, the arithmetic unit 10 generates a narrowband image for the second spectroscopic sensor 4Y. The narrowbanding coefficient C used at this time is a pre-adjustment narrowbanding coefficient C1.

In step S105, the arithmetic unit 10 calculates the post-adjustment narrowbanding coefficient C2. In this processing, various methods such as a least squares method are used.

### <2-6-2. Spectroscopy Application Generation Device>

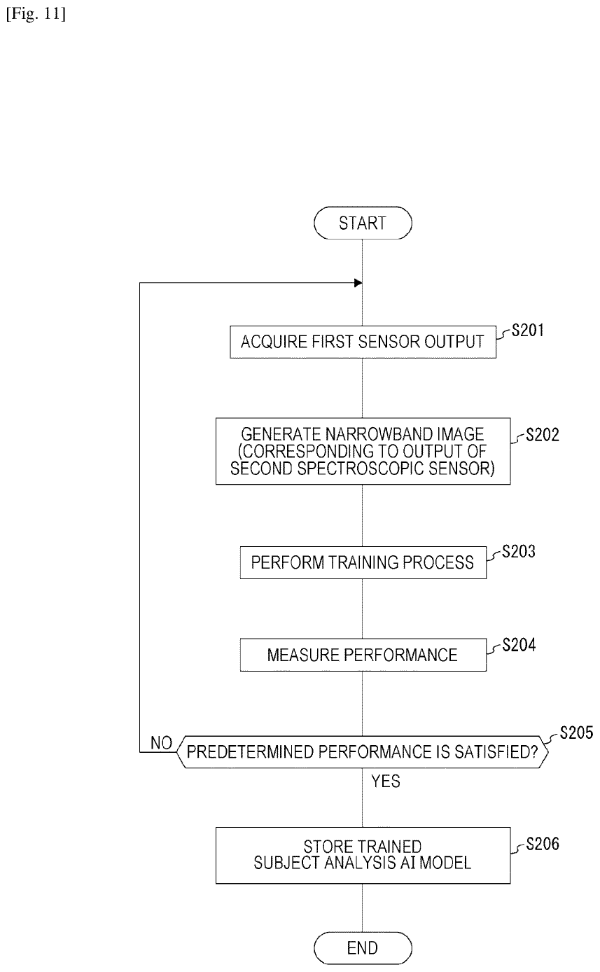

FIG. 11 illustrates an example of a process performed by the spectroscopy application generation device 13 to generate (adjust) the spectroscopy application AP.

In step S201 of FIG. 11, the arithmetic unit 14 of the spectroscopy application generation device 13 acquires the first sensor output OP1 from the first spectroscopic sensor 4X.

In step S202, the arithmetic unit 14 generates a narrowband image by performing matrix operation using the post-adjustment narrowbanding coefficient C2. The narrowband image calculated here is obtained by converting the output of the first spectroscopic sensor 4X into output corresponding to the output of the second spectroscopic sensor 4Y.

In step S203, the arithmetic unit 14 performs a training process using the narrowband image converted into output corresponding to the second spectroscopic sensor 4Y as teacher data.

In step S204, the arithmetic unit 14 measures the performance of the trained subject analysis AI model M2.

In step S205, the arithmetic unit 14 determines whether or not the subject analysis AI model M2 satisfies predetermined performance. In this determination process, for example, an inference result obtained by inputting a specific wavelength band image to the subject analysis AI model M2 is compared with correct answer data, and it is determined whether or not the likelihood information is equal to or more than a threshold value.

In a case where it is determined that the predetermined performance is not satisfied, the arithmetic unit 14 returns to step S201 and acquires new teacher data.

On the other hand, in a case where it is determined that the predetermined performance is satisfied, the arithmetic unit 14 stores the trained subject analysis AI model M2 in the storage unit 17 in step S206.

### <2-6-3. Analysis Device>

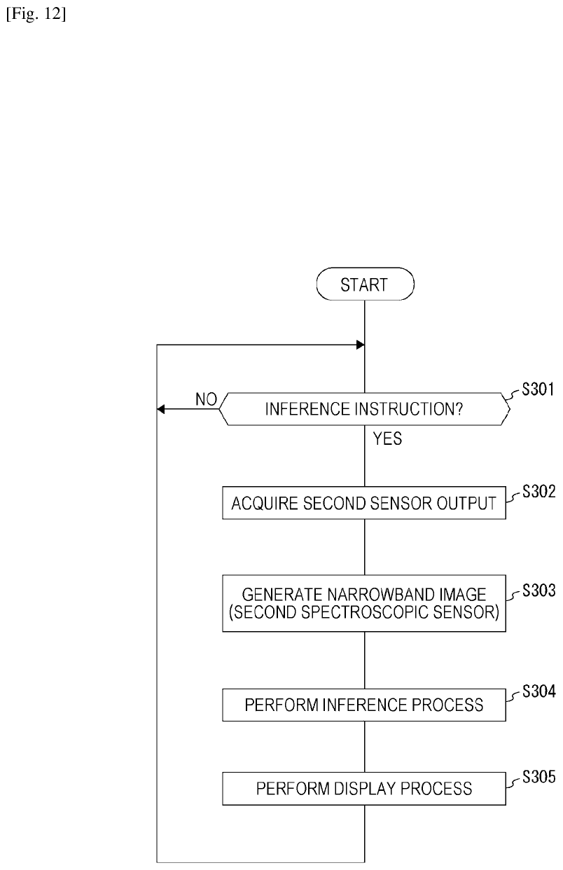

FIG. 12 illustrates an example of a process performed by the analysis device 18 in a case where the subject is analyzed using the trained subject analysis AI model M2.

In step S301, the control unit 19 of the analysis device 18 detects an inference instruction. For example, in a case where the operation unit 25 detects a user operation as an inference instruction, “Yes determination” is made in step S301.

In a case where the inference instruction has not been detected, the control unit 19 performs the process of step S301 again.

In a case where it is determined that the inference instruction has been detected, the spectral image generation unit 20 of the analysis device 18 acquires the second sensor output OP2 from the second spectroscopic sensor 4Y in step S302.

In step S303, the spectral image generation unit 20 generates a narrowband image for the second spectroscopic sensor 4Y. The narrowbanding coefficient C used here is a pre-adjustment narrowbanding coefficient C1.

In step S304, the application processing unit 21 of the analysis device 18 performs an inference process by inputting the narrowband image to the subject analysis AI model M2.

In step S305, the application processing unit 21 of the analysis device 18 performs a display process of the inference result and the likelihood information output from the subject analysis AI model M2.

As a result, for example, the analysis result for the subject is displayed on the display unit 23 or the like of the analysis device 18.

### <2.-7. Relationship Between Devices>

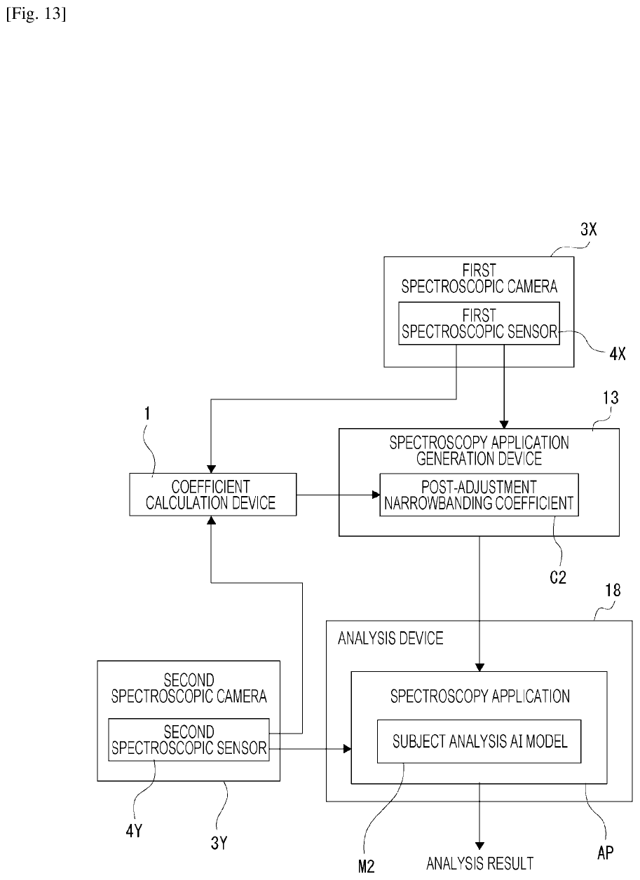

FIG. 13 illustrates an outline of the role of each device in the present embodiment and the flow until deriving the analysis result.

As illustrated, the first sensor output OP1 of the first spectroscopic sensor 4X included in the first spectroscopic camera 3X is input to the spectroscopy application generation device 13.

The spectroscopy application generation device 13 generates the spectroscopy application AP and the subject analysis AI model M2 using the input first sensor output OP1 and the narrowband image converted to output corresponding to the output of the second spectroscopic sensor 4Y using the post-adjustment narrowbanding coefficient C2 as a coefficient of the conversion algorithm.

Note that the post-adjustment narrowbanding coefficient C2 used in the spectroscopy application generation device 13 is calculated and provided by the coefficient calculation device 1.

The spectroscopy application AP including the subject analysis AI model M2 generated by the spectroscopy application generation device 13 is provided to the analysis device 18.

The analysis device 18 analyzes the second sensor output OP2 supplied from the second spectroscopic sensor 4Y included in the second spectroscopic camera 3Y, using the spectroscopy application AP and the subject analysis AI model M2. As a result, the analysis device 18 obtains an analysis result for the subject.

The analysis result (inference result or likelihood information) of the subject obtained by the analysis device 18 can be presented to the user via the display unit 23 or the like or can be provided to an external device.

According to the first embodiment, the subject analysis AI model M2 is generated as optimized for each spectroscopic camera 3. Therefore, each spectroscopic camera 3 does not need to perform a process of converting the output of the spectroscopic sensor 4 into output corresponding to the output of another spectroscopic sensor 4.

As a result, it is possible to reduce the processing load of the spectroscopic camera 3 in a case where the spectroscopic camera 3 performs the inference process or the processing load of the device that performs the inference process using the output of the spectroscopic camera 3.

### 3. SECOND EMBODIMENT

In the second embodiment, simulation is used to generate the post-adjustment narrowbanding coefficient C2. The same configurations and processes as those of the first embodiment are denoted by the same reference numerals, and description thereof will be omitted as appropriate.

### <3-1. Configuration of Algorithm Derivation System>

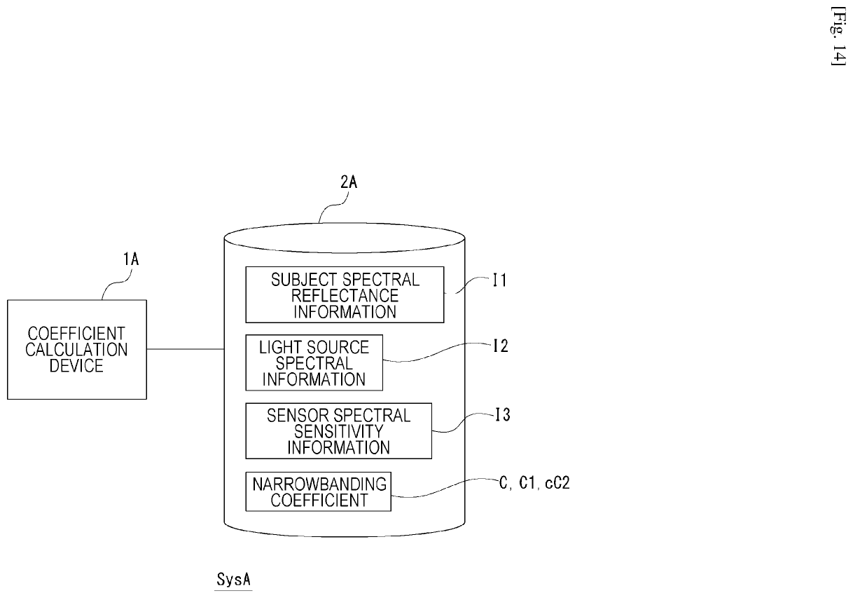

FIG. 14 illustrates a configuration of an algorithm derivation system SysA according to the present embodiment.

The algorithm derivation system SysA includes a coefficient calculation device 1A and a database 2A.

The coefficient calculation device 1A is configured as a computer device, and performs a process of deriving a conversion algorithm for converting the output of the first spectroscopic sensor 4X into output corresponding to the output of the second spectroscopic sensor 4Y.

The coefficient calculation device 1A in this example derives a conversion algorithm for converting the output of the spectroscopic sensor 4 on the basis of subject spectral reflectance information I1, light source spectral information I2, and sensor spectral sensitivity information I3 stored in the storage device as the database 2A.

Here, the subject spectral reflectance information I1 is information indicating the spectral reflectance of the subject, that is, the reflectance for each wavelength.

In addition, the light source spectral information I2 is spectral information about the light source, that is, information indicating light intensity for each wavelength. The spectral information about the light source may be generated on the basis of a signal output from an ambient sensor or the like. Alternatively, in a case where the assumed light source is the sun, the information may be generated on the basis of latitude information, longitude information, date and time information, and further weather information.

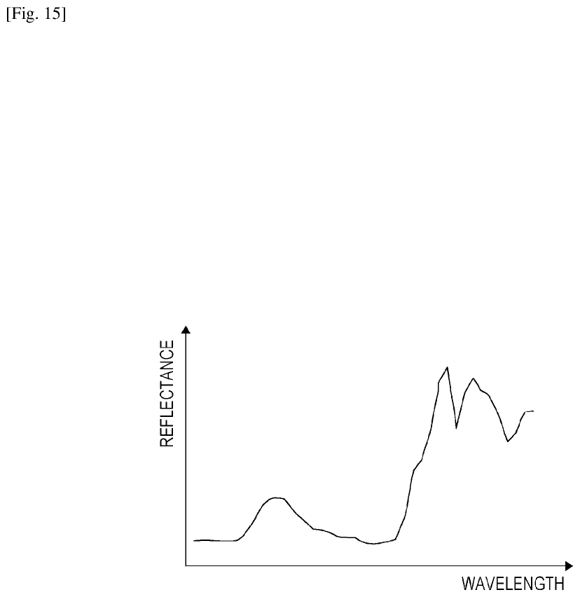

FIG. 15 illustrates an example of the subject spectral reflectance information I1.

In the present embodiment, spectral reflectance information about a subject selected in advance as a target is stored as the subject spectral reflectance information I1.

In the database 2A of FIG. 14, the sensor spectral sensitivity information I3 is information indicating the sensitivity for each wavelength of the spectroscopic sensor 4. As the sensor spectral sensitivity information I3, for example, the information measured with respect to the spectroscopic sensor 4 in advance using a dedicated measurement device or the like is stored in the database 2.

As described above, the spectral sensitivity of the spectroscopic sensor 4 can be different for each individual spectroscopic sensor 4. Therefore, in the present example, the sensor spectral sensitivity information I3 is stored in the database 2A for each of the first spectroscopic sensor 4X for the first spectroscopic camera 3X and the second spectroscopic sensor 4Y for the second spectroscopic camera 3Y.

The coefficient calculation device 1A in the present example performs a process of storing the post-adjustment narrowbanding coefficient C2 as a coefficient of the derived conversion algorithm in the database 2A.

Since the configuration of the coefficient calculation device 1A in the present example is described with reference to FIG. 5, the description thereof will be omitted.

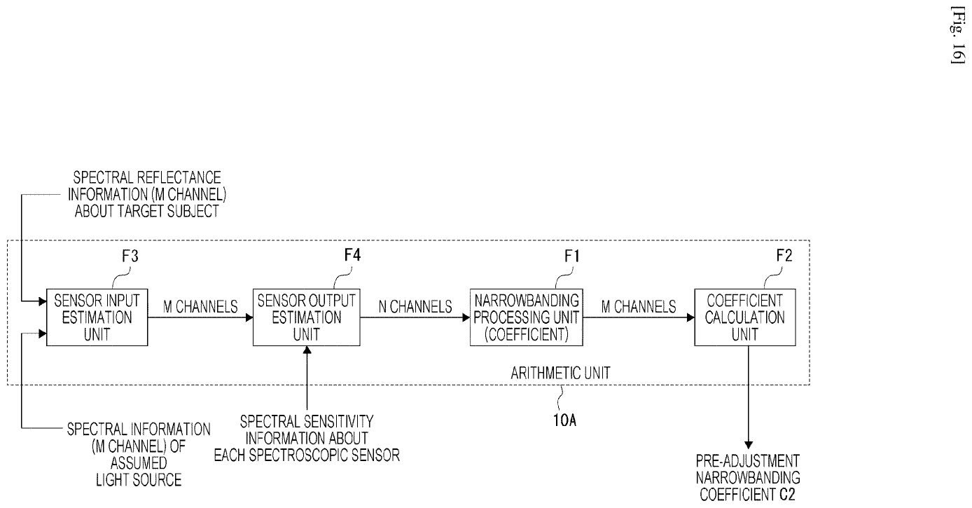

FIG. 16 illustrates a functional configuration of an arithmetic unit 10A of the coefficient calculation device 1A.

As illustrated, the arithmetic unit 10A includes a sensor input estimation unit F3 and a sensor output estimation unit F4 in addition to the narrowbanding processing unit F1 and the coefficient calculation unit F2 as functional units for deriving the coefficient included in the conversion algorithm.

The sensor input estimation unit F3 estimates a sensor input that is spectral information about input light to the spectroscopic sensor 4 on the basis of spectral reflectance information about the target subject and spectral information about the target light source.

Here, in this example, in order to avoid complication of description, it is assumed that there is only one target subject and one target light source. It is conceivable that, for example, “lettuce”, “tomato (leaves of tomato)”, or the like as a target subject can be exemplified in a case where an application that analyzes the growth state of vegetables as the spectroscopy application AP that performs subject analysis on the basis of the narrowband image obtained by the spectroscopic camera 3 is assumed, and “human skin” can be exemplified in a case where an application that performs human skin condition analysis is assumed.

Furthermore, examples of the target light source include the “sun” and various “lighting devices”, for example, a fluorescent lamp, a white bulb, and a light emitting diode (LED).

As illustrated in the drawing, as the spectral reflectance information about the target subject and the spectral information about the target light source, information on the basis of the wavelength resolutions for M channels (that is, information indicating the reflectance and the light intensity for each of the M wavelength channels) is used.

Spectral reflectance information about the target subject and spectral information about the target light source are stored as the subject spectral reflectance information I1 and the light source spectral information 12 in the database 2A illustrated in FIG. 14, respectively.

The sensor input estimation unit F3 acquires the spectral reflectance information about the target subject and the spectral information about the target light source stored as the subject spectral reflectance information I1 and the light source spectral information 12 in the database 2A, and estimates the sensor input on the basis of the spectral reflectance information about the target subject and the spectral information about the target light source. For example, the sensor input is obtained by multiplying the light intensity for each wavelength channel indicated by the spectral information about the target light source by the reflectance of the corresponding wavelength channel indicated by the spectral reflectance information about the target subject.

As a result, the sensor input in the present example is obtained as information indicating the light intensity of each of the M wavelength channels for the input light to the spectroscopic sensor 4.

The sensor output estimation unit F4 estimates a sensor output that is spectral information output by the spectroscopic sensor 4 according to the sensor input on the basis of the spectral sensitivity information about the spectroscopic sensor 4 and the sensor input.

Specifically, the sensor output estimation unit F4 acquires the spectral sensitivity information about the first spectroscopic sensor 4X stored in the database 2 as the sensor spectral sensitivity information 13, and estimates the first sensor output OP1 (for N channels) on the basis of the acquired spectral sensitivity information and the sensor input estimated by the sensor input estimation unit F3.

The sensor output estimation unit F4 estimates the second sensor output OP2 by applying similar processing to the second spectroscopic sensor 4Y.

Here, the estimation of the sensor output involves a wavelength conversion process for reducing the number of wavelengths from M to N, contrary to the narrowbanding process. In this wavelength conversion process, a matrix operation expression for wavelength conversion as in the above [Expression 1] is used. In this case, the spectral sensitivity information about the spectroscopic sensor 4 obtained as information about a coefficient (a coefficient corresponding to the narrowbanding coefficient C in the arithmetic expression of the narrowbanding process) in the arithmetic expression for the wavelength conversion is stored in the database 2 as the sensor spectral sensitivity information 13, and the sensor output estimation unit F4 obtains sensor outputs for N channels by performing a wavelength conversion process on the sensor input by a wavelength conversion arithmetic expression from M channels to N channels in which the coefficient is set.

Note that the sensor spectral sensitivity information 13 for each spectroscopic sensor 4 is obtained on the basis of the output of each impulse response by sequentially irradiating the spectroscopic sensor 4 with single wavelength light of, for example, about 300 nm to about 1000 nm into at intervals of several nm or intervals of several tens of nm.

On the basis of the estimated first sensor output OP1, the narrowbanding processing unit F1 performs a narrowbanding process of estimating spectral information about a larger number of wavelengths than the number of wavelengths of the sensor output to obtain a narrowband image. The narrowbanding coefficient C used at this time is a pre-adjustment narrowbanding coefficient C1.

In addition, the narrowbanding processing unit F1 obtains a narrowband image for the second spectroscopic sensor 4Y on the basis of the estimated second sensor output OP2 and the pre-adjustment narrowbanding coefficient C1.

The coefficient calculation unit F2 obtains the post-adjustment narrowbanding coefficient C2 so as to minimize an error between the wavelength characteristic indicated by the narrowband image of the first spectroscopic sensor 4X obtained by the narrowbanding processing unit F1 and the wavelength characteristic indicated by the narrowband image of the second spectroscopic sensor 4Y.

As described above, the calculated post-adjustment narrowbanding coefficient C2 is used at the time of generating teacher data used for training of the subject analysis AI model M2.

### <3-2. Processing Flow>

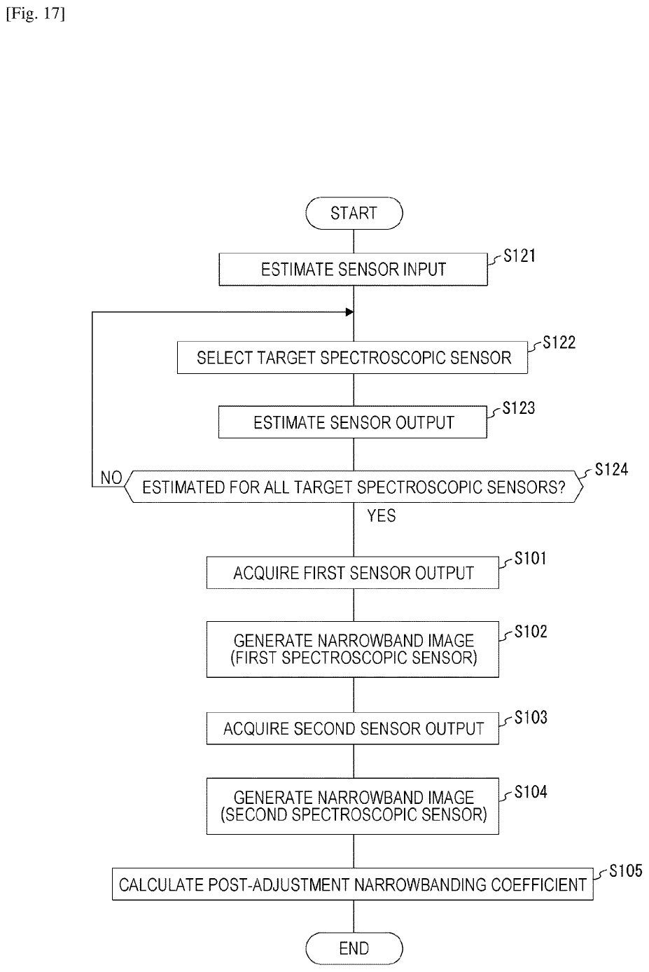

FIG. 17 illustrates an example of a process performed by the coefficient calculation device 1A to calculate the post-adjustment narrowbanding coefficient C2. Note that processes similar to those illustrated in FIG. 10 are denoted by the same step numbers, and description thereof is omitted.

The arithmetic unit 10A of the coefficient calculation device 1 estimates the sensor input to the spectroscopic sensor 4 in step S121 of FIG. 17.

In step S122, the arithmetic unit 10A selects the spectroscopic sensor 4 to be processed, specifically, one of the first spectroscopic sensor 4X and the second spectroscopic sensor 4Y.

Subsequently, in step S123, the arithmetic unit 10A estimates the sensor output for the spectroscopic sensor 4 selected in step S122.

In step S124, the arithmetic unit 10A determines whether or not the sensor output has been estimated for all the spectroscopic sensors 4 to be processed.

In a case where it is determined that the processing has not been completed, the arithmetic unit 10A returns to step S122 and selects the next spectroscopic sensor 4.

On the other hand, in a case where it is determined that the sensor outputs have been estimated for all the spectroscopic sensors 4 to be processed, the arithmetic unit 10A performs each process of steps S101 to S105.

As a result, the arithmetic unit 10 calculates the post-adjustment narrowbanding coefficient C2.

### 4. THIRD EMBODIMENT

In the first and second embodiments, in order to exhibit predetermined inference performance in the spectroscopic sensor 4 (for example, the spectroscopic sensor 4 mounted on a product) used for the inference processing, the process of bringing teacher data used for training the subject analysis AI model M2 close to the narrowband image acquired by the spectroscopic sensor 4 mounted on a product is performed.

In the third embodiment, in order to exhibit predetermined inference performance in the spectroscopic sensor 4 (for example, the spectroscopic sensor 4 mounted on a product) used in the inference processing, the process of bringing the narrowband image of the spectroscopic sensor 4 mounted on a product close to a narrowband image used as teacher data is performed.

That is, in the present embodiment, for example, the spectroscopic sensor 4 mounted on a product is referred to as a first spectroscopic sensor 4X, and the spectroscopic sensor 4 used to obtain teacher data is referred to as a second spectroscopic sensor 4Y.

The coefficient calculation device 1 according to the present embodiment has the same configuration as that of the first and second embodiments (see FIGS. 5 and 6), and thus description thereof is omitted.

### <4-1. Configuration of Spectroscopy Application Generation Device>

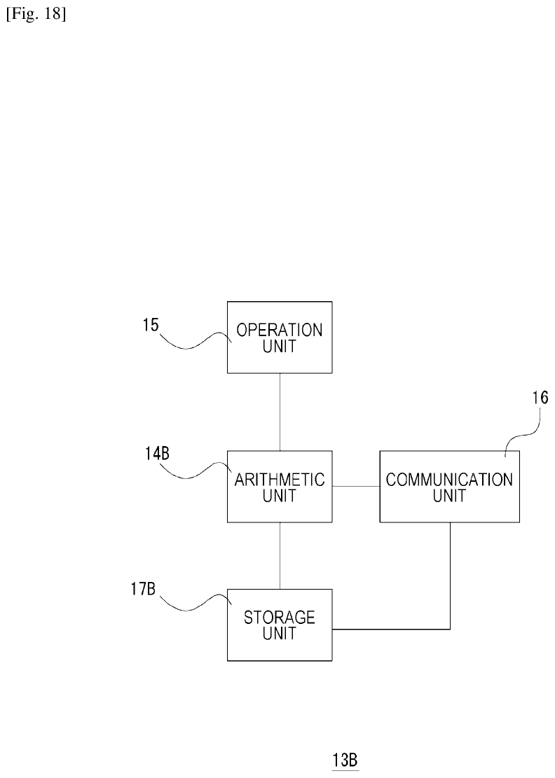

As illustrated in FIG. 18, a spectroscopy application generation device 13B includes an arithmetic unit 14B, the operation unit 15, the communication unit 16, and a storage unit 17B. The same components as those of the spectroscopy application generation device 13 according to the first embodiment are denoted by the same reference numerals, and description thereof will be omitted as appropriate.

The arithmetic unit 14B includes, for example, a microcomputer including a CPU, a ROM, a RAM, and the like, and performs predetermined calculation and overall control of the spectroscopy application generation device 13B by the CPU executing a process bases on a program stored in the ROM or a program loaded in the RAM.

The operation unit 11 includes various operators such as a keyboard, a mouse, a key, a dial, a touch panel, and a touch pad for the user to perform an operation input to the spectroscopy application generation device 13, to output an operation signal corresponding to an operation on the operator to the arithmetic unit 14B.

The communication unit 16 performs wired or wireless data communication with an external device.

The storage unit 17B comprehensively represents various ROMs, RAMs, and the like, and stores programs executed by the arithmetic unit 14B and various pieces of data used for calculation processing.

The pre-adjustment narrowbanding coefficient C1 is stored in the storage unit 17B.

When the arithmetic unit 14B executes a program, the spectroscopy application generation device 13B has a function of generating the spectroscopy application AP.

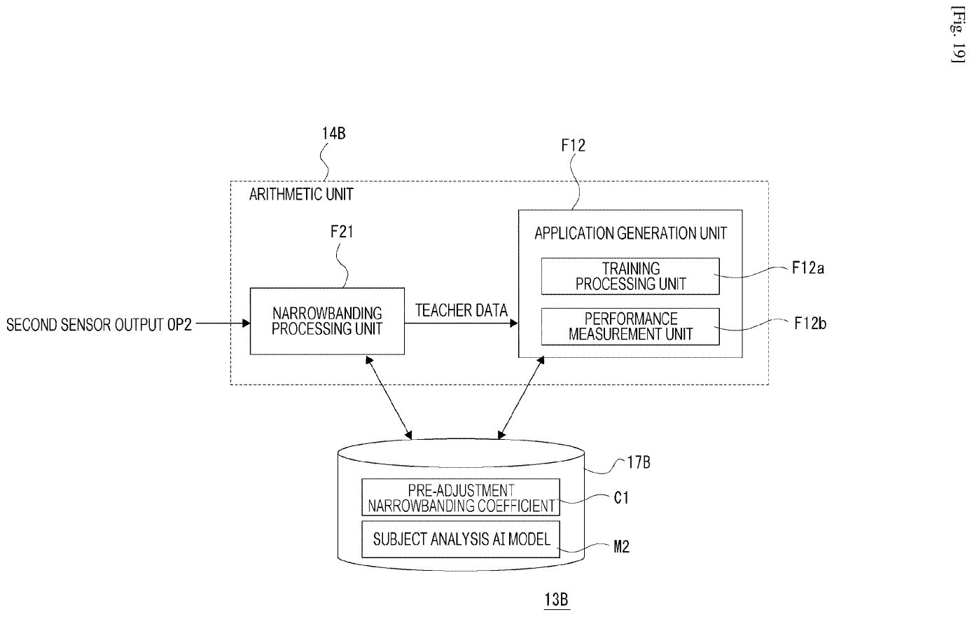

For this purpose, a configuration of the spectroscopy application generation device 13B is illustrated in FIG. 19.

The arithmetic unit 14B of the spectroscopy application generation device 13B includes a narrowbanding processing unit F21 and the application generation unit F12.

The narrowbanding processing unit F21 performs a matrix operation using the second sensor output OP2 for N channels output from the second spectroscopic sensor 4Y and the pre-adjustment narrowbanding coefficient C1 acquired from the storage unit 17B, and generates narrowband images for M channels. Unlike the first embodiment, this process does not also serve as a process of converting into output corresponding to a different spectroscopic sensor 4. That is, the narrowbanding processing unit F21 only performs a narrowbanding process on the second sensor output OP2 to obtain a narrowband image.

The narrowband image generated by the narrowbanding processing unit F21 is provided to the application generation unit F12 as teacher data.

The application generation unit F12 further includes a training processing unit F12a and a performance measurement unit F12b.

The training processing unit F12a performs machine training using the teacher data supplied from the narrowbanding processing unit F21 and trains the subject analysis AI model M2.

The performance measurement unit F12b measures the performance of the trained subject analysis AI model M2 generated by the training processing unit F12a. As a result, the performance measurement unit F12b determines whether or not the generated subject analysis AI model M2 has desired performance.

By repeatedly performing the processing by the training processing unit F12a and the performance measurement unit F12b, the application generation unit F12 generates the trained subject analysis AI model M2 satisfying desired performance. The application generation unit F12 stores the generated subject analysis AI model M2 in the storage unit 17B.

### <4-2. Configuration of Analysis Device>

An analysis device 18B is a device that analyzes the subject using the first sensor output OP1 that is the output from the first spectroscopic sensor 4X and the trained subject analysis AI model M2.

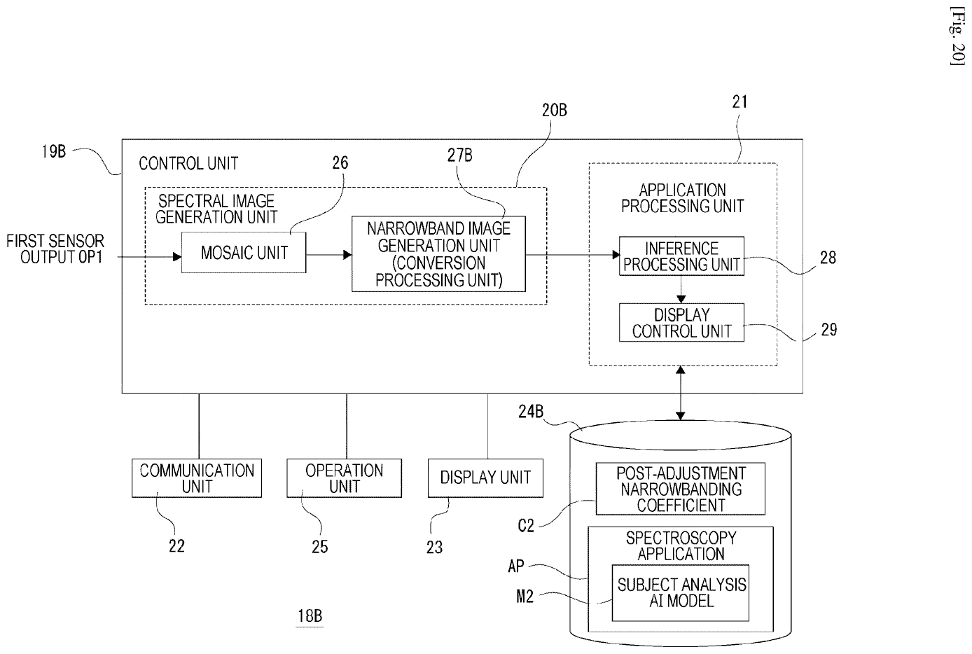

As illustrated in FIG. 20, the analysis device 18B includes a control unit 19B. Note that the same components as those of the analysis device 18 according to the first embodiment are denoted by the same reference numerals, and description thereof will be omitted as appropriate.

The control unit 19B includes, for example, a microcomputer including a CPU, a ROM, a RAM, and the like, and performs overall control of the analysis device 18B by the CPU performing a process bases on, for example, a program stored in the ROM or a program loaded in the RAM.

In addition, the control unit 19B functions as a spectral image generation unit 20B and the application processing unit 21 by executing various programs.

The analysis device 18B further includes the communication unit 22, the display unit 23, a storage unit 24B, and the operation unit 25.

The spectral image generation unit 20B has the same configuration as the spectral image generation unit 5 illustrated in FIG. 1, and includes the demosaic unit 26 and a narrowband image generation unit 27B.

The demosaic unit 26 performs the demosaic process on the first sensor output OP1 that is RAW images for N channels from the first spectroscopic sensor 4X.

The narrowband image generation unit 27B generates narrowband images for M channels by performing a narrowbanding process bases on the respective wavelength band images for N channels obtained by the demosaic process. Here, the narrowband image generation unit 27B generates a narrowband image using the post-adjustment narrowbanding coefficient C2.

That is, the narrowbanding process performed by the narrowband image generation unit 27B also serves as a process of converting the output of the first spectroscopic sensor 4X into output corresponding to the output of the second spectroscopic sensor 4Y.

In response to this, the post-adjustment narrowbanding coefficient C2 is stored in the storage unit 24B.

The inference processing unit 28 of the application processing unit 21 analyzes the subject by inputting a narrowband image obtained by converting the output of the first spectroscopic sensor 4X into output corresponding to the second spectroscopic sensor 4Y to the subject analysis AI model M2 optimized for the second spectroscopic sensor 4Y.

As a result, it is possible to perform the appropriate inference process using the output of the first spectroscopic sensor 4X.

### <4-3. Processing Flow>

An example of a process performed by each device according to the third embodiment will be described.

### <4-3-1. Spectroscopy Application Generation Device>

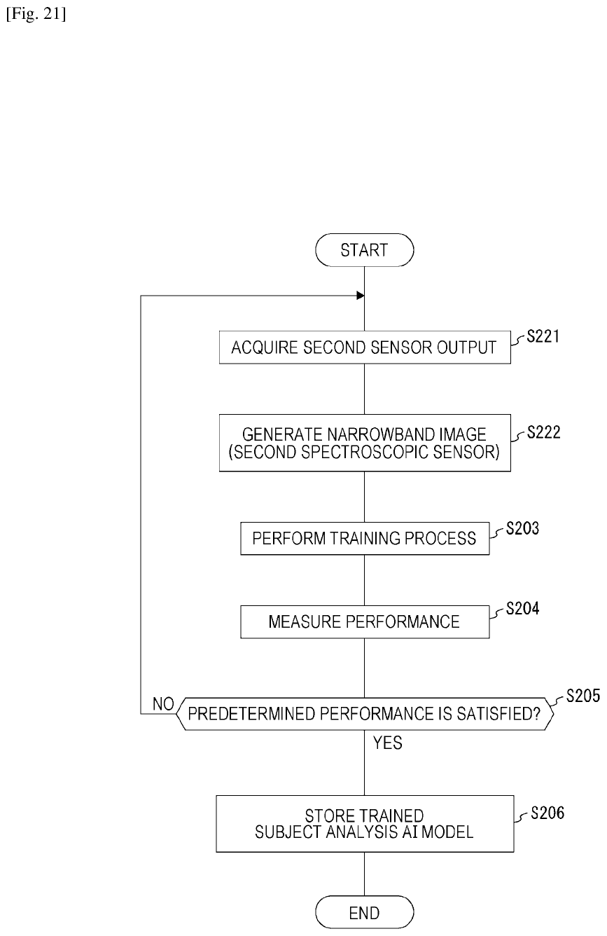

FIG. 21 illustrates an example of a process performed by the spectroscopy application generation device 13B to generate (adjust) the spectroscopy application AP. Note that processes similar to those in FIG. 11 are denoted by the same step numbers.

In step S221 of FIG. 21, the arithmetic unit 14B of the spectroscopy application generation device 13B acquires the second sensor output OP2 from the second spectroscopic sensor 4Y.

In step S222, the arithmetic unit 14B generates a narrowband image by performing calculation using the pre-adjustment narrowbanding coefficient C1. The narrowband image calculated here is obtained by narrowbanding the output of the second spectroscopic sensor 4Y.

The arithmetic unit 14B performs a training process using the narrowband image for the second spectroscopic sensor 4Y as teacher data in step S203, and measures the performance of the trained subject analysis AI model M2 in step S204.

In step S205, the arithmetic unit 14B determines whether or not the subject analysis AI model M2 satisfies the predetermined performance. In a case where it is determined that the subject analysis AI model M2 does not satisfy the predetermined performance, the process returns to step S221. In a case where it is determined that the subject analysis AI model M2 satisfies the predetermined performance, the trained subject analysis AI model M2 is stored in the storage unit 17B in step S206.

### <4-3-2. Analysis Device>

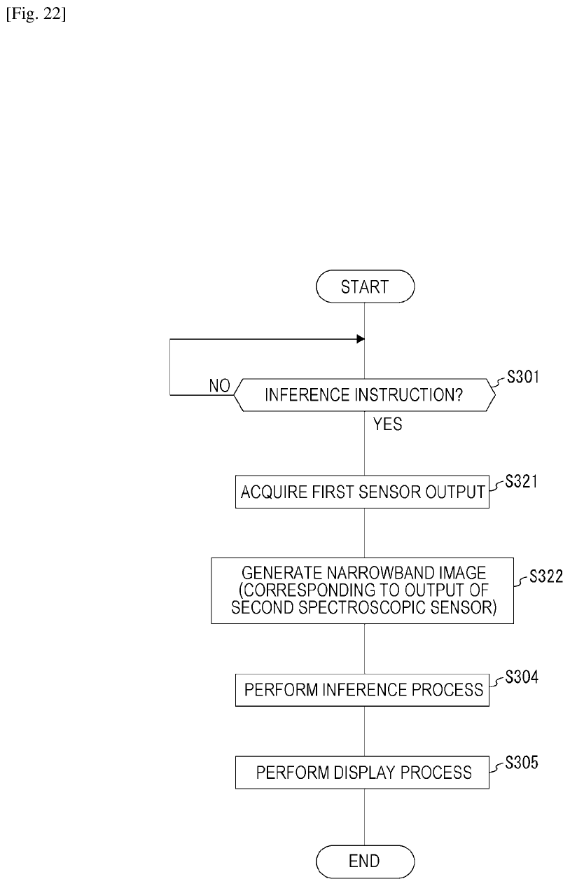

FIG. 22 illustrates an example of a process performed by the analysis device 18B in a case where the subject is analyzed using the trained subject analysis AI model M2. Note that processes similar to those in FIG. 12 are denoted by the same step numbers.

In step S301, the control unit 19 of the analysis device 18B detects an inference instruction.

In a case where the inference instruction has not been detected, the control unit 19 performs the process of step S301 again.

In a case where it is determined that the inference instruction has been detected, the spectral image generation unit 20B of the analysis device 18B acquires the first sensor output OP1 from the first spectroscopic sensor 4X in step S321.

In step S322, the spectral image generation unit 20B generates a narrowband image obtained by converting the sensor output of the first spectroscopic sensor 4X into output corresponding to the output of the second spectroscopic sensor 4Y. The narrowbanding coefficient C used here is the post-adjustment narrowbanding coefficient C2.

In step S304, the application processing unit 21 of the analysis device 18B performs the inference process by inputting the narrowband image to the subject analysis AI model M2.

In step S305, the application processing unit 21 of the analysis device 18B performs a display process of the inference result and the likelihood information output from the subject analysis AI model M2.

As a result, for example, the analysis result for the subject is displayed on the display unit 23 or the like of the analysis device 18B.

### <4.-4. Relationship Between Devices>

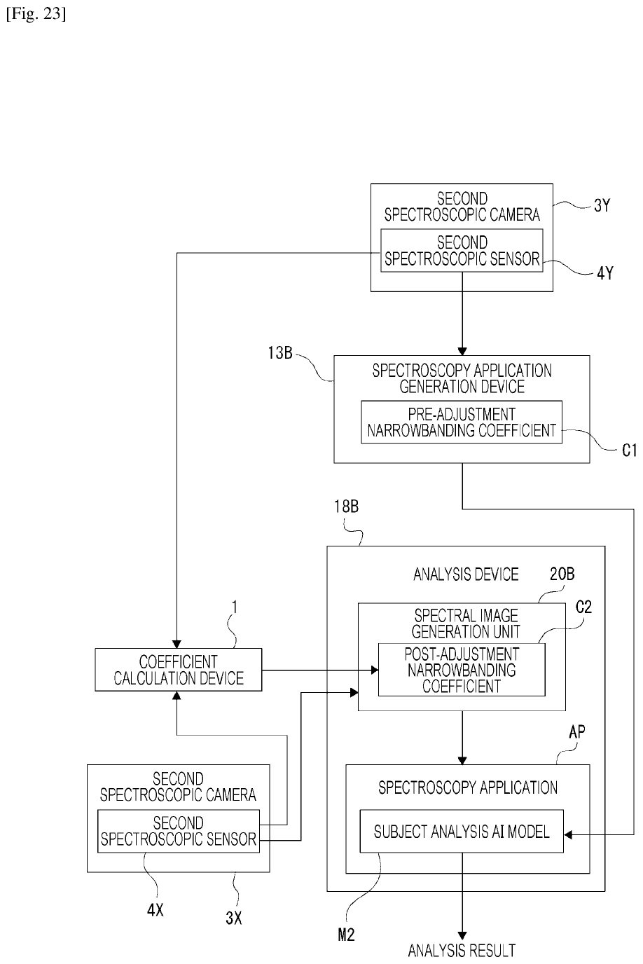

FIG. 23 schematically illustrates the role of each device according to the third embodiment and the flow until deriving the analysis result.

As illustrated, the second sensor output OP2 of the second spectroscopic sensor 4Y included in the second spectroscopic camera 3Y is input to the spectroscopy application generation device 13B.

In the spectroscopy application generation device 13B, the spectroscopy application AP and the subject analysis AI model M2 are generated using the narrowband image bases on the input second sensor output OP2.

The spectroscopy application AP including the subject analysis AI model M2 generated by the spectroscopy application generation device 13B is provided to the analysis device 18B.

In the analysis device 18B, the process of converting the output from the first spectroscopic sensor 4X included in the first spectroscopic camera 3X into a narrowband image corresponding to the output of the second spectroscopic sensor 4Y is performed by the light image generation unit 19B. Note that the post-adjustment narrowbanding coefficient C2 used here is provided from the coefficient calculation device 1.

The narrowband image corresponding to the output of the second spectroscopic sensor 4Y obtained by the spectral image generation unit 20B of the analysis device 18B is input to the spectroscopy application AP. As a result, analysis bases on the first sensor output OP1 supplied from the first spectroscopic sensor 4X included in the first spectroscopic camera 3X is performed using the spectroscopy application AP and the subject analysis AI model M2, and an analysis result for the subject is obtained.

The analysis result (inference result or likelihood information) of the subject obtained by the analysis device 18B can be presented to the user via the display unit 23 or provided to an external device.

According to the third embodiment, the subject analysis AI model M2 is generated only once. Then, in each spectroscopic camera 3, a conversion algorithm for generating an appropriate narrowband image as input data of the subject analysis AI model M2 is applied.

Such an aspect is suitable in a case where it takes several days to generate the subject analysis AI model M2.

### 5. FOURTH EMBODIMENT

In the above-described example, an example is described in which the process of narrowbanding the signals for N channels to M channels has a function (output conversion function) of absorbing the variation in wavelength characteristic between the sensors.

The implementation of the present technology is not limited thereto, and the process of absorbing variations in wavelength characteristic between sensors may be performed after narrowing the band.

First, the narrowband images for M channels are obtained from the wavelength band images for N channels that are the sensor outputs of each spectroscopic sensor 4 using the pre-adjustment narrowbanding coefficient C1.

Here, the pixel value of the m-th channel for the first spectroscopic sensor 4X is Bx[m], and the pixel value of the m-th channel for the second spectroscopic sensor 4Y is By[m].

Assuming that an adjustment coefficient for minimizing J[m] representing the square of the difference between the pixel values of both the spectroscopic sensors for the m-th channel is p[m], J[m] can be expressed by the following Expression [2].

$$[ Math . 2 ]$$

$$J [ m ] = {[ B y [ m ] - \{ B x [ m ] \times p [ m ] \} ]}^{2} \qquad [ Expression 2 ]$$

By appropriately obtaining the adjustment coefficient p[m], the output of the first spectroscopic sensor 4X can be converted into output corresponding to the output of the second spectroscopic sensor 4Y.

Note that Expression [2] is an expression for calculating the adjustment coefficient p using the narrowband image obtained for one subject. In order to cope with all of the various narrowband images obtained by changing the subject, the adjustment coefficient p is calculated so as to minimize J′[m] obtained by integrating J[m] for the various narrowband images.

J′[m] can be expressed by the following Expression [3].

$$[ Math . 3 ]$$

$${J}^{′} [ m ] = {\sum }_{d = 1}^{D} {[ B y [ d , m ] - \{ B x [ d , m ] \times p [ m ] \} ]}^{2} \qquad [ Expression 3 ]$$

where Bx[d, m] is a pixel value of the m-th channel obtained when reflected light from the d-th subject among the D types of subjects is received by the first spectroscopic sensor 4X.

In addition, By[d, m] is a pixel value similarly obtained for the second spectroscopic sensor 4Y.

An adjustment coefficient p[m] that minimizes J′[m] of Expression [3] is obtained for each channel, and the pixel value Bx as the narrowband image of the m-channel of the first spectroscopic sensor 4X is multiplied by the adjustment coefficient p[m], whereby the output can be converted into output corresponding to the output of the second spectroscopic sensor 4Y.

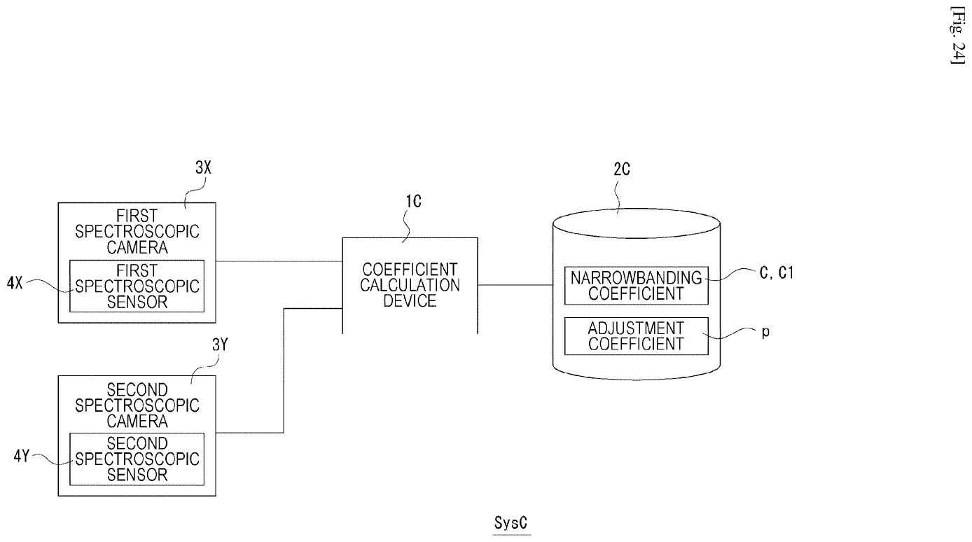

FIG. 24 illustrates a configuration example of an algorithm derivation system SysC according to the fourth embodiment.

The algorithm derivation system SysC includes the first spectroscopic camera 3X, the second spectroscopic camera 3Y, a coefficient calculation device 1C, and a database 2C.

The coefficient calculation device 1C generates narrowband images for M channels from the wavelength band images for N channels for both the first spectroscopic sensor 4X and the second spectroscopic sensor 4Y using the pre-adjustment narrowbanding coefficient C1 stored in the database 2C.

The coefficient calculation device 1C calculates the above-described adjustment coefficient p for converting the output of the first spectroscopic sensor 4X into output corresponding to the output of the second spectroscopic sensor 4Y for each channel.

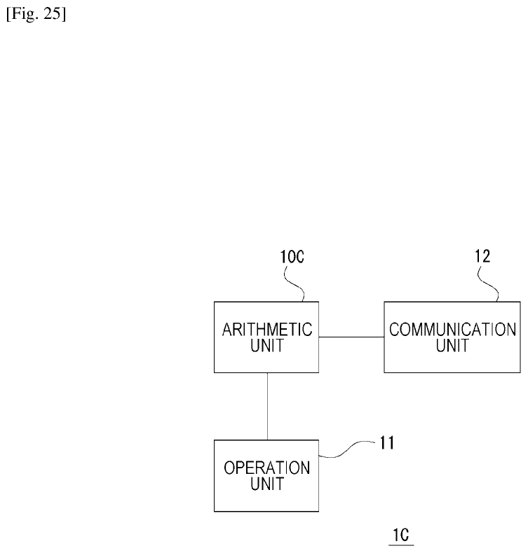

A configuration example of the coefficient calculation device 1C is illustrated in FIG. 25. The coefficient calculation device 1C includes an arithmetic unit 10C, the operation unit 11, and the communication unit 12. Description of the operation unit 11 and the communication unit 12 is omitted.

The arithmetic unit 10C calculates the adjustment coefficient p for each channel by the CPU executing a process bases on a program stored in the ROM or a program loaded in the RAM.

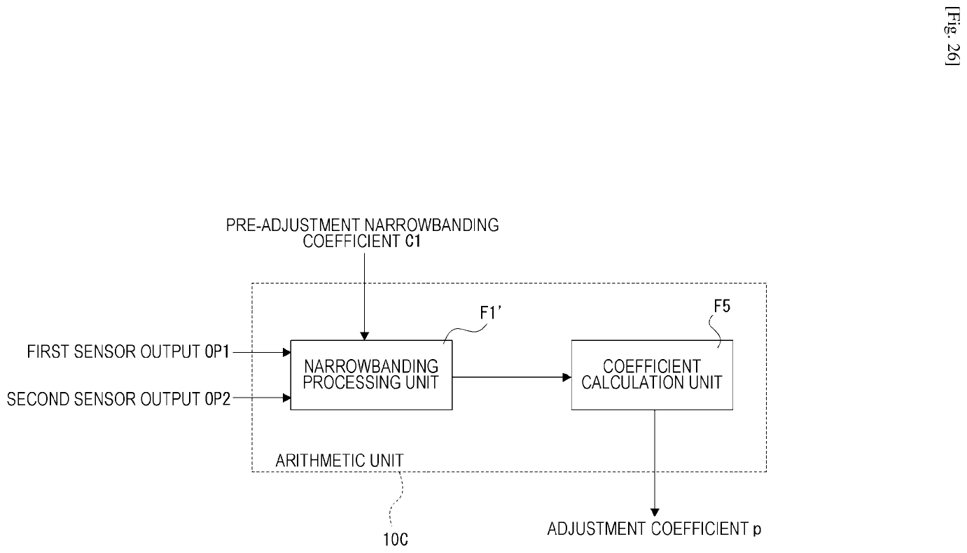

FIG. 26 illustrates a configuration included in the coefficient calculation device 1C for calculating the adjustment coefficient p.

The arithmetic unit 10C of the coefficient calculation device 1C includes a narrowbanding processing unit F1′ and a coefficient calculation unit F5.

The narrowbanding processing unit F1′ generates narrowband images for M channels from the sensor outputs for N channels of each of the first spectroscopic sensor 4X and the second spectroscopic sensor 4Y using the pre-adjustment narrowbanding coefficient C1.

The coefficient calculation unit F5 calculates an adjustment coefficient p for minimizing J[m] (or J′[m]) described above. The adjustment coefficient p is stored in the database 2C, for example.

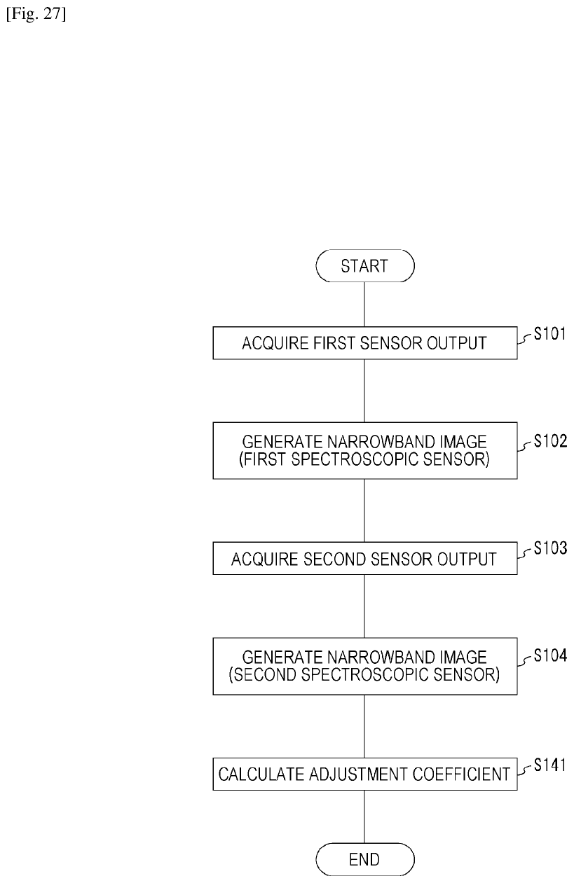

FIG. 27 illustrates an example of a process performed by the coefficient calculation device 1C to calculate the adjustment coefficient p. Note that processes similar to those illustrated in FIG. 10 are denoted by the same step numbers, and description thereof is omitted.

The arithmetic unit 10C of the coefficient calculation device 1C obtains a narrowband image for the first spectroscopic sensor 4X and a narrowband image for the second spectroscopic sensor 4Y by performing each processing from step S101 to step S104.

In step S141, the arithmetic unit 10C calculates the adjustment coefficient p that minimizes J[m] (J′[m]).

The adjustment coefficient p calculated here is multiplied by the pixel value in the narrowband image obtained using the pre-adjustment narrowbanding coefficient C1, whereby the output of a certain spectroscopic sensor 4 can be converted into output corresponding to the output of another spectroscopic sensor 4.

### 6. FIFTH EMBODIMENT

In each example described above, the process of absorbing the difference in wavelength characteristics between the spectroscopic sensors 4 is described.

In the fifth embodiment, in a case where wavelength characteristic vary in one spectroscopic sensor 4, the process of absorbing the variation is performed.

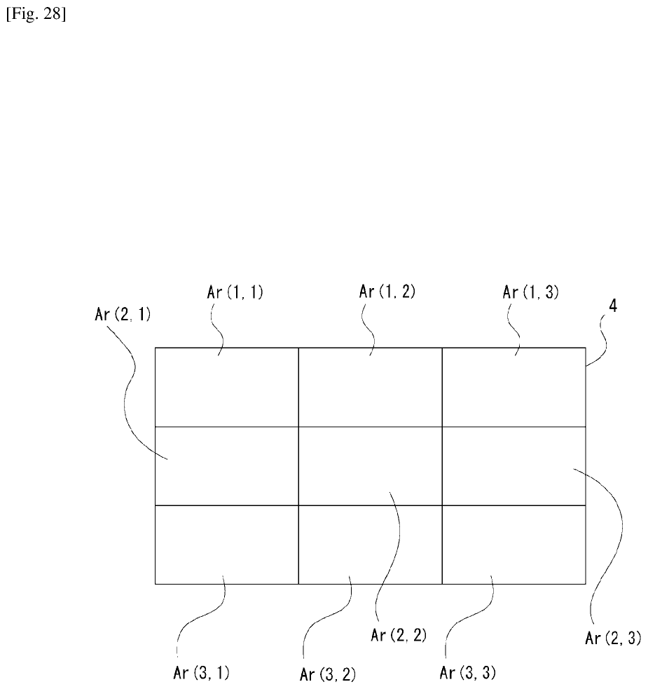

In the present embodiment, as an example, the light receiving face of the spectroscopic sensor 4 is divided into a total of nine regions with three divisions in the row direction and three divisions in the column direction (see FIG. 28). However, this is merely an example, and the spectroscopic sensor 4 may be divided into two regions vertically or horizontally, may be divided into four regions, or may be divided into more regions such as 16 regions.

Among the nine regions divided in the spectroscopic sensor 4, a divided region Ar located at the i-th from the top and the j-th from the left is defined as a divided region Ar(i, j).

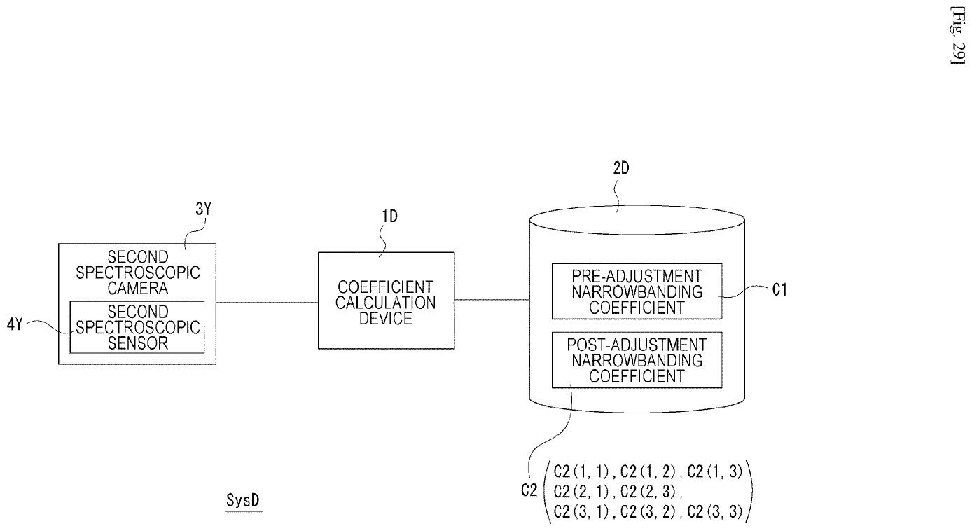

FIG. 29 illustrates a configuration example of an algorithm derivation system SysD according to the present embodiment.

The algorithm derivation system SysD includes a coefficient calculation device 1D, a database 2D, and a second spectroscopic camera 2Y. Note that, in a case where simulation is used as in the second embodiment, the algorithm derivation system SysD may be configured without including the second spectroscopic camera 2Y.

The coefficient calculation device 1D generates the post-adjustment narrowbanding coefficient C2 for each divided region Ar using the wavelength band images for N channels for each divided region Ar output from the second spectroscopic sensor 4Y included in the second spectroscopic camera 3Y.

Here, the coefficient calculation device 1D determines one divided region Ar selected from respective divided regions Ar as a reference region ArB, and calculates the post-adjustment narrowbanding coefficient C2 for each divided region Ar other than the reference region ArB.

As an example, here, a central divided region Ar(2, 2) illustrated in FIG. 28 is defined as the reference region ArB.

The coefficient calculation device 1D calculates a post-adjustment narrowbanding coefficient C2(1, 1) for the divided region Ar(1, 1). The post-adjustment narrowbanding coefficient C2(1, 1) converts the wavelength band images for N channels output from the divided region Ar(1, 1) into narrowband images for M channels output according to the wavelength characteristic of the reference region ArB (=divided region Ar(2, 2)).

That is, the post-adjustment narrowbanding coefficient C2(1, 1) can be said to be a conversion algorithm that converts the output of the divided region Ar(1, 1) into output corresponding to the output of the reference region ArB.

Similarly, for the divided regions Ar(1, 2), Ar(1, 3), Ar(2, 1), Ar(2, 3), Ar(3, 1), Ar(3, 2), and Ar(3, 3), the post-adjustment narrowbanding coefficients C2(1, 2), C2(1, 3), C2(2, 1), C2(2, 3), C2(3, 1), C2(3, 2), and C2(3, 3) are calculated, respectively.

Since the divided region Ar(2, 2) is a reference region, it is not necessary to calculate the post-adjustment narrowbanding coefficient C2(2, 2) for the divided region Ar(2, 2).

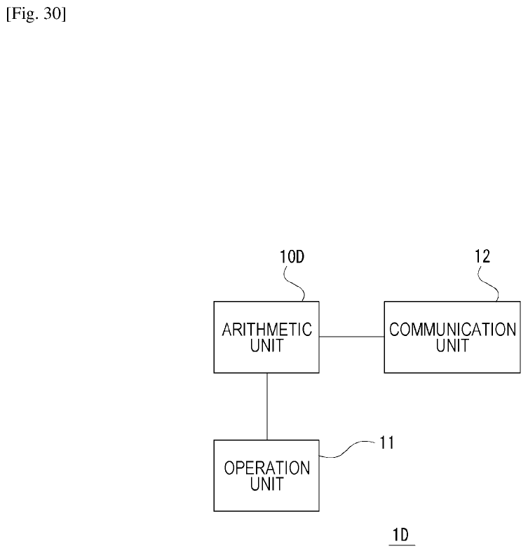

A configuration example of the coefficient calculation device 1D is illustrated in FIG. 30. The coefficient calculation device 1D includes an arithmetic unit 10D, the operation unit 11, and the communication unit 12.

Description of the operation unit 11 and the communication unit 12 is omitted.

The arithmetic unit 10D calculates the post-adjustment narrowbanding coefficient C2 for each of the divided regions Ar other than the reference region ArB by the CPU executing a process bases on a program stored in the ROM or a program loaded in the RAM.

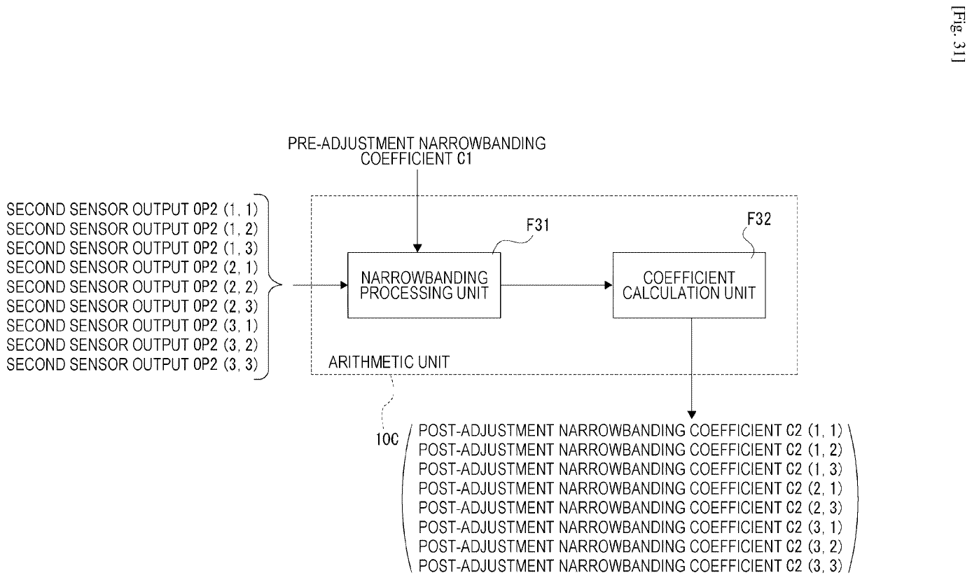

FIG. 31 illustrates a configuration included in the coefficient calculation device 1D for calculating the post-adjustment narrowbanding coefficient C2.

The arithmetic unit 10D of the coefficient calculation device 1D includes a narrowbanding processing unit F31 and a coefficient calculation unit F32 in order to calculate the post-adjustment narrowbanding coefficient C2 for each of the divided regions Ar.

The narrowbanding processing unit F31 generates narrowband images for M channels for each divided region Ar using the second sensor outputs OP2 for N channels for each divided region Ar and the pre-adjustment narrowbanding coefficient C1.

The coefficient calculation unit F32 calculates a post-adjustment narrowbanding coefficient C2 for absorbing a difference between the narrowband image obtained for the reference region ArB in the second spectroscopic sensor 4Y and the narrowband images obtained for the other divided regions Ar. That is, it can be said that the coefficient calculation unit F32 calculates a coefficient included in a conversion algorithm for converting the output of the divided region Ar in the second spectroscopic sensor 4Y into output corresponding to the output of the reference region ArB.

As a method of calculating the post-adjustment narrowbanding coefficient C2, as described above, it is also conceivable to perform processing using the least squares method or processing using a regression analysis algorithm such as Ridge regression or Lasso regression.

Furthermore, the derivation of the coefficient included in the conversion algorithm having the function of converting the output of the divided region Ar in the second spectroscopic sensor 4Y into the output of the reference region ArB may be performed by calculating the weight coefficient included in the AI model.

Note that, here, the method of matching the output of the predetermined region for the spectroscopic sensor 4 with the output of the reference region ArB is described, but the output may be matched with the output of the reference region ArB of a different spectroscopic sensor 4.

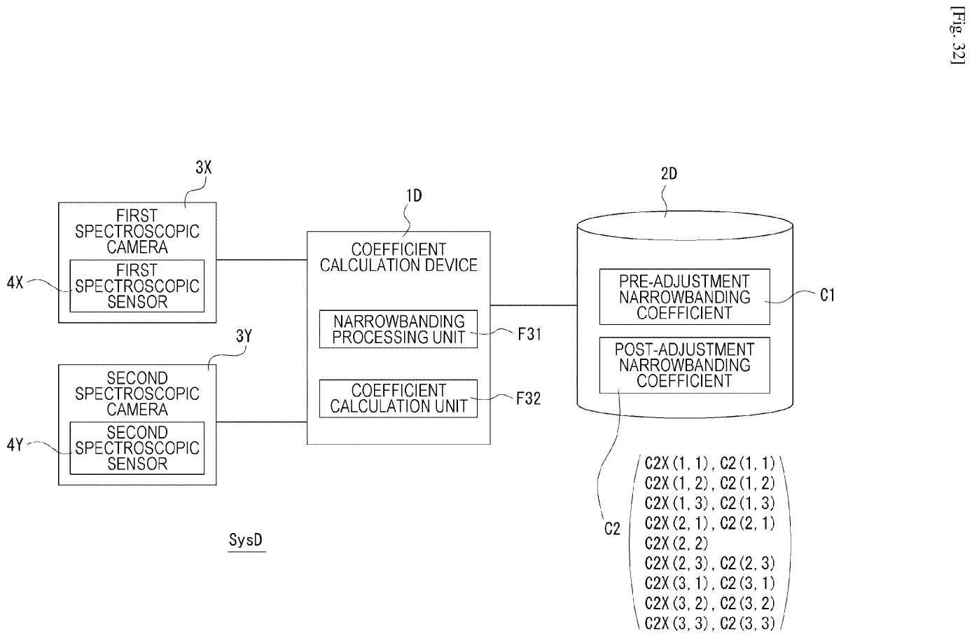

This will be specifically described with reference to FIG. 32.

The coefficient calculation device 1D acquires the first sensor outputs OP1 (1, 1), . . . , OP1 (3, 3) as wavelength band images for N channels for each divided region Ar from the first spectroscopic sensor 4X of the first spectroscopic camera 3X.

In addition, the coefficient calculation device 1D acquires second sensor outputs OP2 (1, 1), . . . , OP2 (3, 3) as wavelength band images for N channels for each divided regions Ar from the second spectroscopic sensor 4Y of the second spectroscopic camera 3Y.

Then, the coefficient calculation device 1D determines, for example, a divided region Ar(2, 2) that is a central region of the second spectroscopic sensor 4Y as the reference region ArB.

The narrowbanding processing unit F31 of the coefficient calculation device 1D obtains narrowband images for each divided regions Ar of the first spectroscopic sensor 4X and the second spectroscopic sensor 4Y using each sensor output OP and the pre-adjustment narrowbanding coefficient C1.

The coefficient calculation unit F32 calculates nine post-adjustment narrowbanding coefficients C2X(1, 2), C2X(1, 3), C2X(2, 1), C2X(2,3), C2X(3, 1), C2X(3, 2), and C2X(3, 3) for the divided regions Ar(1, 1), Ar(1, 2), Ar(1, 3), Ar(2, 1), Ar(2, 2), Ar(2, 3), Ar(3, 1), Ar(3, 2), and Ar(3, 3) of the first spectroscopic sensor 4X.

Furthermore, the coefficient calculation unit F32 calculates eight post-adjustment narrowbanding coefficients C2(1, 2), C2(1, 3), C2(2, 1), C2(2, 3), C2(3, 1), C2(3, 2), and C2(3, 3) for the divided regions Ar(1, 1), Ar(1, 2), Ar(1, 3), Ar(2, 1), Ar(2, 3), Ar(3, 1), Ar(3, 2), and Ar(3, 3) other than the reference region ArB of the second spectroscopic sensor 4Y.

As described above, the coefficient calculation device 1D calculates the post-adjustment narrowbanding coefficient C2 as a coefficient of the conversion algorithm in order to absorb variations in wavelength characteristic within a plane and between sensors in the spectroscopic sensor 4.

By converting the output from each divided region Ar into output corresponding to the output of the reference region ArB, the ideal narrowband image obtained by the ideal spectroscopic sensor 4 having the uniform wavelength characteristic can be used as teacher data of the AI model.

In addition, by using the post-adjustment narrowbanding coefficient C2 for each divided region Ar for the narrowband image as the input data given to the subject analysis AI model M2 obtained in this manner, it is possible to use a narrowband image close to the teacher data while correcting the variation in the in-plane wavelength characteristic in the spectroscopic sensor 4.

Therefore, the inference accuracy using the subject analysis AI model M2 can be improved.

Then, it is possible to generate the optimal subject analysis AI model M2 corresponding to the spectroscopic sensor 4 as in the first embodiment and to use the same subject analysis AI model M2 for the inference process bases on output of a different spectroscopic sensor 4 as in the third embodiment.

In a case where the reference region ArB is selected from the plurality of divided regions Ar in the spectroscopic sensor 4, it is desirable to select the divided region Ar having the highest inference accuracy as the reference region ArB.

In addition, it is also preferable to select a region including the central portion of the spectroscopic sensor 4 as the reference region ArB as the divided region Ar having a small adverse effect by the lens.

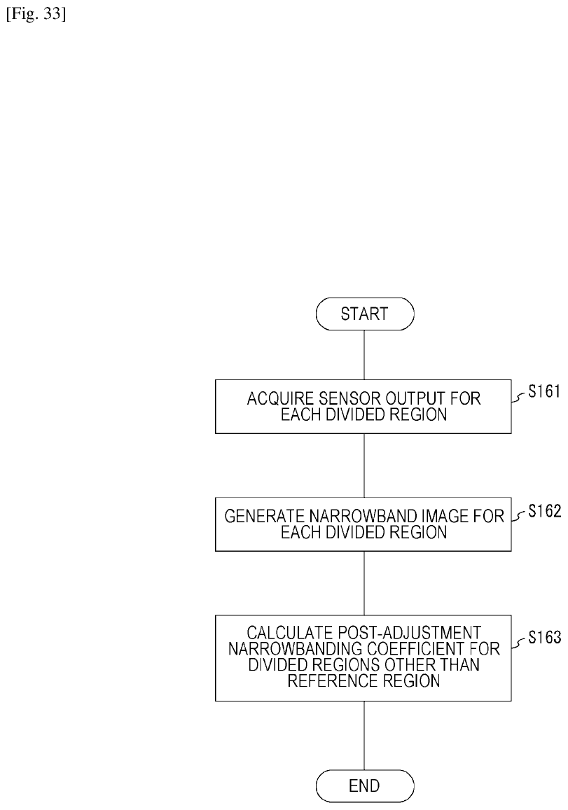

FIG. 33 illustrates an example of a process performed by the arithmetic unit 10D of the coefficient calculation device 1D to generate the post-adjustment narrowbanding coefficient C2 for each of the divided regions Ar.

In step S161, the arithmetic unit 10D acquires the sensor output for each divided region Ar.

In step S162, the arithmetic unit 10D generates a narrowband image for each divided region Ar using the pre-adjustment narrowbanding coefficient C1.

In step S163, the arithmetic unit 10D calculates a post-adjustment narrowbanding coefficient C2(C2X) for the divided region Ar other than the reference region ArB.

### 7. MODIFICATIONS

A spectroscopy application device 13 may include the coefficient calculation device 1 and the database 2 illustrated in FIG. 4, or the coefficient calculation device 1A and the database 2A illustrated in FIG. 14.

For example, the coefficient calculation device 1A of the spectroscopy application generation device 13 calculates the post-adjustment narrowbanding coefficient C2 by using the subject spectral reflectance information I1, the light source spectral information 12, and the sensor spectral sensitivity information I3.

The narrowbanding processing unit F11 of the spectroscopy application generation device 13 generates teacher data using the calculated post-adjustment narrowbanding coefficient C2.

The training processing unit F12a of the application generation unit F12 can acquire the trained subject analysis AI model M2 optimized for the second spectroscopic sensor 4Y by training the subject analysis AI model M2 using the teacher data.

That is, the spectroscopy application generation device 13 may calculate the coefficients (the post-adjustment narrowbanding coefficient C2 and the adjustment coefficient p) for the conversion algorithm using the input subject spectral reflectance information I1, light source spectral information 12, and sensor spectral sensitivity information I3, and then generate the trained subject analysis AI model M2.

In addition, another device such as the coefficient calculation device 1 (1A) may have the same configuration.

In addition, in the generation of such a subject analysis AI model M2, a parameter capable of adjusting the time spent for generating the AI model may be used. By adjusting this parameter, the time that may be required for generating (training) the AI model can be shortened, and the accuracy of the inference result of the AI model can be improved.

In addition, such a spectroscopy application generation device 13 may be able to output accuracy information and reliability information about an inference result assumed for the generated AI model, and information regarding excess or deficiency of teacher data used for training, together with the trained subject analysis AI model M2. The user can determine whether or not to perform additional training or determine the use condition of the trained subject analysis AI model M2 on the basis of the information output from the spectroscopy application generation device 13.

Note that, in the example described above, for example, an example is described in which the wavelength band images for eight channels for the first spectroscopic sensor 4X are converted into narrowband images for 41 channels for the second spectroscopic sensor 4Y, but the present disclosure is not limited thereto.

For example, the coefficient calculation device 1 may include the coefficient calculation unit F2 that calculates the coefficient for converting the wavelength band images for eight channels for the first spectroscopic sensor 4X into the wavelength band images for eight channels for the second spectroscopic sensor 4Y.

That is, the coefficient calculation unit F2 may perform coefficient calculation for converting wavelength band images for N channels for a certain spectroscopic sensor 4 into wavelength band images for N channels for a different spectroscopic sensor 4.

### 8. NOTES

As used herein, an element or step recited in the singular and proceeded with the word “a” or “an” should be understood as not excluding plural elements or steps, unless such exclusion is explicitly recited. Furthermore, references to “one embodiment” of the present invention are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may include at least lossless encoding and decoding using inverse orthogonal transforms in an image processing system.

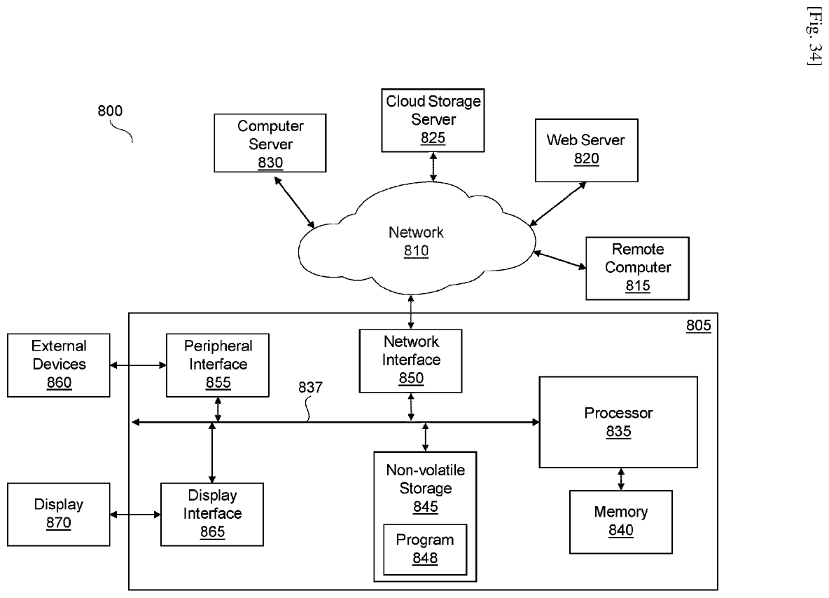

FIG. 34 illustrates a block diagram of a computer that may implement the various embodiments described herein.

The present disclosure may be embodied as a system, a method, and/or a computer program product. The computer program product may include a computer readable storage medium on which computer readable program instructions are recorded that may cause one or more processors to carry out aspects of the embodiment.

The computer readable storage medium may be a tangible device that can store instructions for use by an instruction execution device (processor). The computer readable storage medium may be, for example, but is not limited to, an electronic storage device, a magnetic storage device, an optical storage device, an electromagnetic storage device, a semiconductor storage device, or any appropriate combination of these devices. A nonexhaustive list of more specific examples of the computer readable storage medium includes each of the following (and appropriate combinations): flexible disk, hard disk, solid-state drive (SSD), random access memory (RAM), read-only memory (ROM), erasable programmable readonly memory (EPROM or Flash), static random access memory (SRAM), compact disc (CD or CD-ROM), digital versatile disk (DVD) and memory card or stick. A computer readable storage medium, as used in this disclosure, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described in this disclosure can be downloaded to an appropriate computing or processing device from a computer readable storage medium or to an external computer or external storage device via a global network (i.e., the Internet), a local area network, a wide area network and/or a wireless network. The network may include copper transmission wires, optical communication fibers, wireless transmission, routers, firewalls, switches, gateway computers and/or edge servers. A network adapter card or network interface in each computing or processing device may receive computer readable program instructions from the network and forward the computer readable program instructions for storage in a computer readable storage medium within the computing or processing device.

Computer readable program instructions for carrying out operations of the present disclosure may include machine language instructions and/or microcode, which may be compiled or interpreted from source code written in any combination of one or more programming languages, including assembly language, Basic, Fortran, Java, Python, R, C, C++, C# or similar programming languages. The computer readable program instructions may execute entirely on a user's personal computer, notebook computer, tablet, or smartphone, entirely on a remote computer or compute server, or any combination of these computing devices. The remote computer or compute server may be connected to the user's device or devices through a computer network, including a local area network or a wide area network, or a global network (i.e., the Internet). In some embodiments, electronic circuitry including, for example, programmable logic circuitry, field-programmable gate arrays (FPGA), or programmable logic arrays (PLA) may execute the computer readable program instructions by using information from the computer readable program instructions to configure or customize the electronic circuitry, in order to perform aspects of the present disclosure.

The computer readable program instructions that may implement the systems and methods described in this disclosure may be provided to one or more processors (and/or one or more cores within a processor) of a general purpose computer, special purpose computer, or other programmable apparatus to produce a machine, such that the instructions, which execute via the processor of the computer or other programmable apparatus, create a system for implementing the functions specified in the flow diagrams and block diagrams in the present disclosure. These computer readable program instructions may also be stored in a computer readable storage medium that can direct a computer, a programmable apparatus, and/or other devices to function in a particular manner, such that the computer readable storage medium having stored instructions is an article of manufacture including instructions which implement aspects of the functions specified in the flow diagrams and block diagrams in the present disclosure.

The computer readable program instructions may also be loaded onto a computer, other programmable apparatus, or other device to cause a series of operational steps to be performed on the computer, other programmable apparatus or other device to produce a computer implemented process, such that the instructions which execute on the computer, other programmable apparatus, or other device implement the functions specified in the flow diagrams and block diagrams in the present disclosure.

FIG. 34 is a functional block diagram illustrating a networked system 800 of one or more networked computers and servers. In an embodiment, the hardware and software environment illustrated in FIG. 34 may provide an exemplary platform for implementation of the software and/or methods according to the present disclosure.

Referring to FIG. 34, a networked system 800 may include, but is not limited to, computer 805, network 810, remote computer 815, web server 820, cloud storage server 825 and compute server 830. In some embodiments, multiple instances of one or more of the functional blocks illustrated in FIG. 34 may be employed.

Additional detail of computer 805 is shown in FIG. 34. The functional blocks illustrated within computer 805 are provided only to establish exemplary functionality and are not intended to be exhaustive. And while details are not provided for remote computer 815, web server 820, cloud storage server 825 and compute server 830, these other computers and devices may include similar functionality to that shown for computer 805.

Computer 805 may be a personal computer (PC), a desktop computer, laptop computer, tablet computer, netbook computer, a personal digital assistant (PDA), a smart phone, or any other programmable electronic device capable of communicating with other devices on network 810.

Computer 805 may include processor 835, bus 837, memory 840, non-volatile storage 845, network interface 850, peripheral interface 855 and display interface 865. Each of these functions may be implemented, in some embodiments, as individual electronic subsystems (integrated circuit chip or combination of chips and associated devices), or, in other embodiments, some combination of functions may be implemented on a single chip (sometimes called a system on chip or SoC).

Processor 835 may be one or more single or multi-chip microprocessors, such as those designed and/or manufactured by Intel Corporation, Advanced Micro Devices, Inc. (AMD), Arm Holdings (Arm), Apple Computer, etc. Examples of microprocessors include Celeron, Pentium, Core i3, Core i5 and Core i7 from Intel Corporation; Opteron, Phenom, Athlon, Turion and Ryzen from AMD; and Cortex-A, Cortex-R and Cortex-M from Arm.

Bus 837 may be a proprietary or industry standard high-speed parallel or serial peripheral interconnect bus, such as ISA, PCI, PCI Express (PCI-e), AGP, and the like.

Memory 840 and non-volatile storage 845 may be computer-readable storage media. Memory 840 may include any suitable volatile storage devices such as Dynamic Random Access Memory (DRAM) and Static Random Access Memory (SRAM). Non-volatile storage 845 may include one or more of the following: flexible disk, hard disk, solid-state drive (SSD), read-only memory (ROM), erasable programmable read-only memory (EPROM or Flash), compact disc (CD or CD-ROM), digital versatile disk (DVD) and memory card or stick.

Program 848 may be a collection of machine readable instructions and/or data that is stored in non-volatile storage 845 and is used to create, manage and control certain software functions that are discussed in detail elsewhere in the present disclosure and illustrated in the drawings. In some embodiments, memory 840 may be considerably faster than non-volatile storage 845. In such embodiments, program 848 may be transferred from non-volatile storage 845 to memory 840 prior to execution by processor 835.

Computer 805 may be capable of communicating and interacting with other computers via network 810 through network interface 850. Network 810 may be, for example, a local area network (LAN), a wide area network (WAN) such as the Internet, or a combination of the two, and may include wired, wireless, or fiber optic connections. In general, network 810 can be any combination of connections and protocols that support communications between two or more computers and related devices.

Peripheral interface 855 may allow for input and output of data with other devices that may be connected locally with computer 805. For example, peripheral interface 855 may provide a connection to external devices 860. External devices 860 may include devices such as a keyboard, a mouse, a keypad, a touch screen, and/or other suitable input devices. External devices 860 may also include portable computer-readable storage media such as, for example, thumb drives, portable optical or magnetic disks, and memory cards. Software and data used to practice embodiments of the present disclosure, for example, program 848, may be stored on such portable computer-readable storage media. In such embodiments, software may be loaded onto non-volatile storage 845 or, alternatively, directly into memory 840 via peripheral interface 855. Peripheral interface 855 may use an industry standard connection, such as RS-232 or Universal Serial Bus (USB), to connect with external devices 860.

Display interface 865 may connect computer 805 to display 870. Display 870 may be used, in some embodiments, to present a command line or graphical user interface to a user of computer 805. Display interface 865 may connect to display 870 using one or more proprietary or industry standard connections, such as VGA, DVI, DisplayPort and HDMI.

As described above, network interface 850, provides for communications with other computing and storage systems or devices external to computer 805. Software programs and data discussed herein may be downloaded from, for example, remote computer 815, web server 820, cloud storage server 825 and compute server 830 to non-volatile storage 845 through network interface 850 and network 810. Furthermore, the systems and methods described in this disclosure may be executed by one or more computers connected to computer 805 through network interface 850 and network 810. For example, in some embodiments the systems and methods described in this disclosure may be executed by remote computer 815, computer server 830, or a combination of the interconnected computers on network 810.

Data, datasets and/or databases employed in embodiments of the systems and methods described in this disclosure may be stored and or downloaded from remote computer 815, web server 820, cloud storage server 825 and computer server 830.

Combination of connections and protocols that support communications between two or more computers and related devices.

Obviously, numerous modifications and variations of the present invention are possible in light of the above teachings. It is therefore to be understood that within the scope of the appended claims, the invention may be practiced otherwise than as specifically described herein.

### 9. SUMMARY

As described in each of the examples described above, the coefficient calculation device 1 (1A, 1C, 1D) as an information processing device includes the coefficient calculation unit F2 (F5, F32) that calculates a coefficient (post-adjustment narrowbanding coefficient C2, C2X or adjustment coefficient p) included in a conversion algorithm that converts the first sensor output OP1 that is spectral information output by the first spectroscopic sensor 4X, into different output.

Then, the coefficient calculation unit F2 (F5, F32) calculates the coefficient so that the different output obtained by inputting the first sensor output OP1 to the conversion algorithm approaches the second sensor output OP2 that is spectral information output by the second spectroscopic sensor 4Y different from the first spectroscopic sensor 4X. Note that the “second sensor output OP2” here does not necessarily refer to the wavelength band images for N channels output from the second spectroscopic sensor 4Y, but may refer to narrowband images for M channels calculated on the basis of the wavelength band images for N channels.

It is difficult for the spectroscopic sensor 4 to have a uniform wavelength characteristic due to high manufacturing difficulty. According to the present configuration, the coefficient of the conversion algorithm used to absorb the difference in wavelength characteristics between the first spectroscopic sensor 4X and the second spectroscopic sensor 4Y, in other words, to bring the wavelength characteristic indicated by the output of the first spectroscopic sensor 4X close to the wavelength characteristic indicated by the output of the second spectroscopic sensor 4Y is calculated.

By using the conversion algorithm to which the coefficient calculated here is applied, when the spectroscopy application AP specialized for the second spectroscopic sensor 4Y is created, it is possible to convert the output of the first spectroscopic sensor 4X into output corresponding to the output of the second spectroscopic sensor 4Y and the converted output can be used. In addition, in a case where the spectroscopy application AP specialized for the second spectroscopic sensor 4Y is created, the spectroscopy application AP can be used in the first spectroscopic sensor 4X by converting the output of the first spectroscopic sensor 4X into output corresponding to the output of the second spectroscopic sensor 4Y.

That is, it is possible to use a different spectroscopic sensor 4 while securing the performance of the spectroscopy application AP.

Therefore, the time and cost that may be required for generating the spectroscopy application AP can be reduced.

Note that the conversion algorithm may be a conversion formula using the matrix operation or may be one using the output conversion AI model M1. The above-described coefficient in the case of using the output conversion AI model M1 is a weight coefficient of the output conversion AI model M1 or the like.

As described with reference to FIG. 3 and the like, in the coefficient calculation device 1 (1A, 1D) as an information processing device, the conversion algorithm may be a matrix operation using the coefficient matrix C (post-adjustment narrowbanding coefficient C2) in which a plurality of the coefficients is disposed in N rows and M columns where N is the number of wavelengths of the first sensor output OP1 input to the conversion algorithm and M is the number of wavelengths of the different output output from the conversion algorithm.

That is, a coefficient matrix can be used when the first sensor output OP1 is converted into output corresponding to the second sensor output OP2. As a result, the above-described functions and effects can be obtained by matrix operation.

As described with reference to FIG. 3 and the like, in the coefficient calculation device 1 (1A, 1D) as the information processing device, the matrix operation may also serve as a narrowbanding process of estimating outputs for a larger number of wavelengths than the number of input wavelengths by setting M to a value larger than N.

For example, N, which is the number of wavelengths of the first sensor output OP1, is set to “8”, and M, which is the number of wavelengths of the different output, is set to “41”. As a result, it is possible to bring the output of the first spectroscopic sensor 4X close to the output of the second spectroscopic sensor 4Y for each wavelength subdivided after the narrowbanding process.

Therefore, the output of the first spectroscopic sensor 4X can be further converted into output corresponding to the output of the second spectroscopic sensor 4Y.

As described with reference to FIGS. 6, 14, 16, and the like, the coefficient calculation unit F2 (F5, F32) in the coefficient calculation device 1 (1A, 1C, 1D) as the information processing device may calculate the coefficient (post-adjustment narrowbanding coefficient C2, C2X or adjustment coefficient p) using the first wavelength characteristic that is the sensitivity information with respect to the wavelength of the first spectroscopic sensor 4X and the second wavelength characteristic that is the sensitivity information with respect to the wavelength of the second spectroscopic sensor 4Y.

As a result, it is not necessary to use the first sensor output OP1 and the second sensor output OP2 obtained by actually imaging the subject using the first spectroscopic sensor 4X and the second spectroscopic sensor 4Y as the actual machine.

In other words, a model imitating the first spectroscopic sensor 4X is created using the first wavelength characteristic, and a model imitating the second spectroscopic sensor 4Y is created using the second wavelength characteristic. Then, by inputting the input to the spectroscopic sensor 4 estimated on the basis of the spectral reflectance information for each subject and the light source spectral information obtained from the database to each model, the output from each spectroscopic sensor 4 can be obtained in simulation.

As a result, it is possible to calculate a coefficient of a conversion algorithm for converting the output of the first spectroscopic sensor 4X into output corresponding to the output of the second spectroscopic sensor 4Y on simulation.

By using the sensor output obtained in these simulations, it is possible to reduce the time cost when actually imaging the subject, and it is possible to efficiently calculate the coefficient included in the conversion algorithm.

As described in FIGS. 7 and 8, the modification, and the like, the coefficient calculation device 1 (1A, 1D) as the information processing device may include the application generation unit F12 that generates the spectroscopy application AP by which predetermined performance is obtained in a case where the different output is input.

The spectroscopy application AP is an application that analyzes a subject by inputting output of the spectroscopic sensor 4. Specifically, an application for analyzing a growth state of vegetables in the agricultural field and an application for analyzing a health condition of a patient in the medical field correspond to the spectroscopy application AP.

In a case where such a spectroscopy application AP is assumed, by applying a conversion algorithm for absorbing an error in manufacturing the spectroscopic sensor 4, it is possible to analyze the subject with high accuracy even if a different spectroscopic sensor 4 is used.

As described with reference to FIGS. 7 and 8 and the like, in the coefficient calculation device 1 (1A, 1C, 1D) as the information processing device, the spectroscopy application AP may perform the inference process using the subject analysis AI model M2.

That is, the spectroscopy application AP is an application including the subject analysis AI model M2 that performs predetermined inference on the subject using the image (narrowband image) expressing the wavelength characteristic output from the spectroscopic sensor 4 by imaging the subject as input data.

The teacher data used for training the subject analysis AI model M2 is various images captured by an originally different spectroscopic sensor 4. Therefore, since the inference specialized for the spectral image that is the sensor output of the specific spectroscopic sensor 4 is not performed, the inference accuracy may be degraded in a case where the inference is performed using the sensor output of the specific spectroscopic sensor 4. However, according to the present configuration, by applying the conversion algorithm for converting the sensor output of the first spectroscopic sensor 4X for obtaining the teacher data into, for example, output corresponding to the sensor output of the second spectroscopic sensor 4Y mounted on the actual product, the subject analysis AI model M2 can be trained using the teacher data corresponding to the sensor output obtained by the actual product. That is, it is assumed that the trained subject analysis AI model M2 is obtained by applying training specialized for the second spectroscopic sensor 4Y mounted on the product.

Therefore, the inference accuracy at the time of actual operation can be improved.

As described with reference to each of FIGS. 14 to 17, the coefficient calculation device 1A (1C, 1D) as an information processing device may include the sensor input estimation unit F3 that estimates input to the first spectroscopic sensor 4X and the second spectroscopic sensor 4Y and the sensor output estimation unit F4 that estimates output from the first spectroscopic sensor 4X and the second spectroscopic sensor 4Y, and the coefficient calculation unit F2 (F5, F32) may calculate the coefficient (post-adjustment narrowbanding coefficient C2, C2X or adjustment coefficient p) on the basis of the estimated input and the estimated output.

That is, the coefficient calculation unit F2 (F5, F32) calculates a coefficient for converting the output of the first spectroscopic sensor 4X into output corresponding to the output of the second spectroscopic sensor 4Y in simulation.

As a result, it is not necessary to use the spectroscopic sensor 4 as an actual machine for coefficient calculation, and the coefficient calculation can be simplified.

As described with reference to each of FIGS. 14 to 17, the sensor input estimation unit F3 in the coefficient calculation device 1A (1C, 1D) as the information processing device may estimate the input using the information for estimating the light source.

As a result, it is possible to estimate an appropriate input according to the light source, and it is possible to suitably absorb the difference in wavelength characteristic for each spectroscopic sensor 4.

As described above, the information processing method performed by the coefficient calculation device 1 (1A, 1C, 1D) as the information processing device includes performing the process of calculating the coefficient (post-adjustment narrowbanding coefficient C2, C2X or adjustment coefficient p) included in the conversion algorithm that converts the first sensor output OP1 that is the spectral information output by the first spectroscopic sensor 4X into different output, and the coefficient is calculated so that the different output obtained by inputting the first sensor output OP1 into the conversion algorithm approaches the second sensor output OP2 that is the spectral information output by the second spectroscopic sensor 4Y different from the first spectroscopic sensor 4X.

A program readable by a computer device as the coefficient calculation device 1 (1A, 1C, 1D) causes the computer device to execute calculating a coefficient (post-adjustment narrowbanding coefficient C2, C2X or adjustment coefficient p) included in a conversion algorithm that converts the first sensor output OP1 that is spectral information output by a first spectroscopic sensor 4X, into different output, and to implement a function of calculating the coefficient so that the different output obtained by inputting the first sensor output OP1 into the conversion algorithm approaches the second sensor output OP2 that is spectral information output by the second spectroscopic sensor 4Y different from the first spectroscopic sensor 4X.

The above-described various functions and effects can also be obtained by such an information processing method or program.

As described above, the spectroscopy application generation device 13 (alternatively, the analysis device 18B) as an information processing device includes the conversion processing unit (narrowbanding processing unit F11, narrowband image generation unit 27B) that converts the first sensor output OP1 that is the spectral information output by the first spectroscopic sensor 4X into output different from the first sensor output OP1 by inputting the first sensor output OP1 to the conversion algorithm.

The coefficient (post-adjustment narrowbanding coefficient C2, C2X or adjustment coefficient p) included in the conversion algorithm is a coefficient calculated so that the different output obtained by inputting the first sensor output OP1 to the conversion algorithm approaches the second sensor output OP2 that is spectral information output by the second spectroscopic sensor 4Y different from the first spectroscopic sensor 4X.

It is difficult for the spectroscopic sensor 4 to have a uniform wavelength characteristic due to the high design difficulty level and manufacturing difficulty level of the optical filter. The coefficient of the conversion algorithm used in the present configuration is a coefficient optimized to absorb the difference in wavelength characteristics between the first spectroscopic sensor 4X and the second spectroscopic sensor 4Y, in other words, to bring the wavelength characteristic indicated by the output of the first spectroscopic sensor 4X close to the wavelength characteristic indicated by the output of the second spectroscopic sensor 4Y.

By using such a conversion algorithm, when the spectroscopy application AP specialized for the second spectroscopic sensor 4Y is created, the output of the first spectroscopic sensor 4X can be converted into output corresponding to the output of the second spectroscopic sensor 4Y and the converted output can be used. In addition, in a case where the spectroscopy application AP specialized for the second spectroscopic sensor 4Y is created, the spectroscopy application AP can be used in the first spectroscopic sensor 4X by converting the output of the first spectroscopic sensor 4X into output corresponding to the output of the second spectroscopic sensor 4Y.

That is, it is possible to use a different spectroscopic sensor 4 while securing the performance of the spectroscopy application AP.

Therefore, the time and cost that may be required for generating the spectroscopy application AP can be reduced.

Note that the conversion algorithm may be a conversion formula using a matrix operation, or may use an AI model (output conversion AI model M1). The above-described coefficient in the case of using the AI model is a weight coefficient of the AI model or the like.

As described with reference to FIG. 3 and the like, in the spectroscopy application generation device 13 (Alternatively, the analysis device 18B) as an information processing device, the conversion algorithm may be a matrix operation using the coefficient matrix C (post-adjustment narrowbanding coefficient C2) in which a plurality of the coefficients is disposed in N rows and M columns where N is the number of wavelengths of the first sensor output OP1 input to the conversion algorithm and M is the number of wavelengths of the different output output from the conversion algorithm.

That is, a coefficient matrix can be used when the first sensor output OP1 is converted into output corresponding to the second sensor output OP2. As a result, the above-described functions and effects can be obtained by matrix operation.

As described with reference to FIG. 3 and the like, in the spectroscopy application generation device 13 (Alternatively, the analysis device 18B) as the information processing device, the conversion algorithm may include the narrowbanding process of estimating outputs for a larger number of wavelengths than the number of input wavelengths.

For example, N, which is the number of wavelengths of the first sensor output OP1, is set to “8”, and M, which is the number of wavelengths of the different output, is set to “24”. As a result, it is possible to bring the output of the first spectroscopic sensor 4X close to the output of the second spectroscopic sensor 4Y for each wavelength subdivided after the narrowbanding process.

Therefore, the output of the first spectroscopic sensor 4X can be further converted into output corresponding to the output of the second spectroscopic sensor 4Y.

As described with reference to FIG. 20 and the like, the analysis device 18B as the information processing device may include the application processing unit 21 that inputs the different output to the spectroscopy application AP that performs a predetermined process by inputting spectral information to obtain a processing result of the predetermined process, and the spectroscopy application AP may be optimized to obtain predetermined performance in a case where the different output is used as input data.

The spectroscopy application AP is, for example, an application for analyzing a growth state of vegetables in the agricultural field or an application for analyzing a health condition of a patient in the medical field is the spectroscopy application AP.

According to the present configuration, such input data to the spectroscopy application AP is obtained by converting the output of the first spectroscopic sensor 4X into output corresponding to the output of the second spectroscopic sensor 4Y.

That is, by converting the sensor output of the second spectroscopic sensor 4Y into output corresponding to the output of the first spectroscopic sensor 4X used for developing the spectroscopy application AP, the spectroscopy application AP assumed to receive the sensor output of the first spectroscopic sensor 4X can be used while maintaining the performance in the second spectroscopic sensor 4Y.

In addition, when the spectroscopy application AP is developed, it is not necessary to consider the wavelength characteristic of the second spectroscopic sensor 4Y mounted on the actual product, and thus, it is possible to reduce the number of development steps and the development cost.

As described with reference to FIG. 20 and the like, in the analysis device 18B as the information processing device, the spectroscopy application AP may perform the inference process using the subject analysis AI model M2.

The subject analysis AI model M2 corresponds to the subject analysis AI model M2 described above. The inference accuracy of the spectral image as the teacher data used for training the subject analysis AI model M2 and the spectral image as the input data at the time of actual inference using the trained subject analysis AI model M2 may greatly change due to the error in the wavelength characteristic due to the individual difference of the spectroscopic sensor 4. Therefore, it is desirable that the spectroscopic sensor 4 used at the time of training the subject analysis AI model M2 and the spectroscopic sensor 4 used at the time of inference be the same.

However, according to the present configuration, even if the spectroscopic sensor 4 used at the time of training and the spectroscopic sensor 4 used at the time of inference are different, it is possible to suppress a decrease in inference accuracy. That is, it is not necessary to consider the individual differences in the spectroscopic sensor 4 at the time of generating the subject analysis AI model M2. Specifically, it is not necessary to prepare various spectral images in consideration of individual differences in the spectroscopic sensor 4 as the training data of the subject analysis AI model M2.

Therefore, the time cost that may be required for training the subject analysis AI model M2 and the time cost and expense that may be required for preparing the training data can be reduced.

As described in the first embodiment with reference to FIG. 20 and the like, the information processing method performed by the spectroscopy application generation device 13 (alternatively, the analysis device 18B) as the information processing device includes performing a process of converting the first sensor output OP1 that is the spectral information output by the first spectroscopic sensor 4X into output different from the first sensor output OP1 by inputting the first sensor output OP1 to the conversion algorithm, and the coefficient (post-adjustment narrowbanding coefficient C2, C2X or adjustment coefficient p) included in the conversion algorithm is a coefficient calculated so that the different output obtained by inputting the first sensor output OP1 to the conversion algorithm approaches the second sensor output OP2 that is the spectral information output by the second spectroscopic sensor 4Y different from the first spectroscopic sensor 4X.

The above-described various functions and effects can be obtained also by such an information processing method.

As described above, the analysis device 18 as the image processing device includes the storage unit 24 (24B) that stores the spectroscopy application AP that performs a predetermined process with the second sensor output OP2 that is spectral information output by the second spectroscopic sensor 4Y different from the first spectroscopic sensor 4X as input, and the application processing unit 21 that inputs the second sensor output OP2 to the spectroscopy application AP to obtain a processing result of the predetermined process.

Then, the spectroscopy application AP is assumed to be optimized so as to obtain predetermined performance in a case where the converted output obtained by applying predetermined conversion to the first sensor output OP1 that is the spectral information output by the first spectroscopic sensor 4X is used as input data, and the predetermined conversion is conversion using a conversion algorithm that brings the converted output close to the second sensor output OP2.

The spectroscopy application AP is optimized so as to obtain predetermined performance when data corresponding to the second sensor output OP2 obtained by converting the first sensor output OP1 using a conversion algorithm to which a coefficient for absorbing a difference in wavelength characteristics between the first spectroscopic sensor 4X and the second spectroscopic sensor 4Y is applied is input. That is, the sensor output of the second spectroscopic sensor 4Y is unnecessary for generating the spectroscopy application AP.

Therefore, for example, the spectroscopy application AP can be generated or adjusted without using the second spectroscopic sensor 4Y as a product to be sold to the user, and the number of times of use of the product before shipment can be suppressed to a low level.

The image processing method performed by the analysis device 18 as the image processing device includes performing a process of storing the spectroscopy application AP that performs a predetermined process with the second sensor output OP2 that is spectral information output by a second spectroscopic sensor 4Y different from the first spectroscopic sensor 4X as input, and performing a process of inputting the second sensor output OP2 to the spectroscopy application AP to obtain a processing result of the predetermined process, and the spectroscopy application AP is optimized so as to obtain predetermined performance in a case where converted output obtained by applying predetermined conversion to the first sensor output OP1 that is spectral information output by the first spectroscopic sensor 4X is used as input data, and the predetermined conversion is conversion using a conversion algorithm that brings the converted output close to the second sensor output OP2.

The above-described various functions and effects can be obtained also by such an information processing method.

Note that the effects described in the present specification are merely examples and are not limited, and other effects may be provided.

In addition, the above-described examples may be combined in any way, and the above-described various functions and effects can be obtained even in a case where various combinations are used.

### 10. PRESENT TECHNOLOGY

The present technology can also adopt the following configurations.

(1)

An information processing device including
a coefficient calculation unit configured to calculate a coefficient included in a conversion algorithm for converting first sensor output into different output, the first sensor output being spectral information output by a first spectroscopic sensor, wherein
the coefficient calculation unit calculate the coefficient so that the different output obtained by inputting the first sensor output to the conversion algorithm approaches second sensor output, the second sensor output being spectral information output by a second spectroscopic sensor different from the first spectroscopic sensor.
   (2)

The information processing device according to Item (1), wherein
the conversion algorithm is a matrix operation using a coefficient matrix in which a plurality of the coefficients is disposed in N rows and M columns where N is the number of wavelengths of the first sensor output input to the conversion algorithm and M is the number of wavelengths of the different output output from the conversion algorithm.
   (3)

The information processing device according to Item (2), wherein
the matrix operation also serves as a narrowbanding process of estimating output for a larger number of wavelengths than the number of input wavelengths by setting the M to a value large than the N.
   (4)

The information processing device according to any one of Items (1) to (3), wherein
the coefficient calculation unit calculate the coefficient using a first wavelength characteristic that is sensitivity information with respect to a wavelength of the first spectroscopic sensor and a second wavelength characteristic that is sensitivity information with respect to a wavelength of the second spectroscopic sensor.
   (5)

The information processing device according to any one of Items (1) to (4), further including
an application generation unit configured to generate a spectroscopy application by which predetermined performance is obtained in a case where the different output is input.
   (6)

The information processing device according to Item (5), wherein
the spectroscopy application performs an inference process using an AI model.
   (7)

The information processing device according to any one of Items (1) to (6), further including
a sensor input estimation unit configured to estimate input to the first spectroscopic sensor and the second spectroscopic sensor, and
a sensor output estimation unit configured to estimate output from the first spectroscopic sensor and the second spectroscopic sensor, wherein
the coefficient calculation unit calculates the coefficient on the basis of the estimated input and the estimated output.
   (8)

The information processing device according to Item (7), wherein
the sensor input estimation unit estimate the input using information for estimating a light source.
   (9)

An information processing method performed by an information processing device, including
performing a process of calculating a coefficient included in a conversion algorithm for converting first sensor output into different output, the first sensor output being spectral information output by a first spectroscopic sensor, wherein
the coefficient is calculated so that the different output obtained by inputting the first sensor output to the conversion algorithm approaches second sensor output, the second sensor output being spectral information output by a second spectroscopic sensor different from the first spectroscopic sensor.
   (10)

A program readable by a computer device, the program causing the computer device to execute calculating a coefficient included in a conversion algorithm for converting a first sensor output into different output, the first sensor output being spectral information output from a first spectroscopic sensor, and
to implement a function of calculating the coefficient so that the different output obtained by inputting the first sensor output to the conversion algorithm approaches second sensor output, the second sensor output being spectral information output by a second spectroscopic sensor different from the first spectroscopic sensor.
   (11)

An information processing device including
a conversion processing unit configured to input first sensor output, the first sensor output being spectral information output by a first spectroscopic sensor, to a conversion algorithm to convert the first sensor output into output different from the first sensor output, wherein
a coefficient included in the conversion algorithm is a coefficient calculated so that the different output obtained by inputting the first sensor output to the conversion algorithm approaches second sensor output, the second sensor output being spectral information output by a second spectroscopic sensor different from the first spectroscopic sensor.
   (12)

The information processing device according to Item (11), wherein
the conversion algorithm is a matrix operation using a coefficient matrix in which a plurality of the coefficients is disposed in N rows and M columns where N is the number of wavelengths of the first sensor output input to the conversion algorithm and M is the number of wavelengths of the different output output from the conversion algorithm.
   (13)

The information processing device according to Item (12), wherein
the conversion algorithm includes a narrowbanding process of estimating output for a larger number of wavelengths than the number of input wavelengths.
   (14)

The information processing device according to any one of Items (11) to (13), including
an application processing unit configured to input the different output to a spectroscopy application that performs a predetermined process by inputting spectral information to obtain a processing result of the predetermined process, wherein the spectroscopy application is optimized to obtain predetermined performance in a case where the different output is used as input data.
   (15)

The information processing device according to Item (14), wherein
the spectroscopy application performs an inference process using an AI model.
   (16)

An information processing method performed by an information processing device, including
performing a process of inputting first sensor output, the first sensor output being spectral information output by a first spectroscopic sensor, to a conversion algorithm to convert the first sensor output into output different from the first sensor output, wherein
a coefficient included in the conversion algorithm is a coefficient calculated so that the different output obtained by inputting the first sensor output to the conversion algorithm approaches second sensor output, the second sensor output being spectral information output by a second spectroscopic sensor different from the first spectroscopic sensor.
   (17)

An image processing device including
a storage unit that stores a spectroscopy application that performs a predetermined process with second sensor output as input, the second sensor output being spectral information output by a second spectroscopic sensor different from a first spectroscopic sensor, and
an application processing unit configured to input the second sensor output to the spectroscopy application to obtain a processing result of the predetermined process, wherein
the spectroscopy application is optimized so as to obtain predetermined performance in a case where converted output obtained by applying predetermined conversion to first sensor output, the first sensor output being spectral information output by the first spectroscopic sensor, is used as input data, and wherein
the predetermined conversion is conversion using a conversion algorithm that brings the converted output close to the second sensor output.
   (18)

An image processing method performed by an image processing device, including:
performing a process of storing a spectroscopy application that performs a predetermined process with second sensor output as input, the second sensor output being spectral information output by a second spectroscopic sensor different from a first spectroscopic sensor, and
performing a process of inputting the second sensor output to the spectroscopy application to obtain a processing result of the predetermined process, wherein
the spectroscopy application is optimized so as to obtain predetermined performance in a case where converted output obtained by applying predetermined conversion to first sensor output, the first sensor output being spectral information output by the first spectroscopic sensor, is used as input data, and
the predetermined conversion is conversion using a conversion algorithm that brings the converted output close to the second sensor output.

### REFERENCE SIGNS LIST

1, 1A, 1C, 1D Coefficient calculation device (information processing device)
4 Spectroscopic sensor (first spectroscopic sensor, second spectroscopic sensor)
4X First spectroscopic sensor
4Y Second spectroscopic sensor
4a Pixel array unit
13, 13B Spectroscopy application generation device (information processing device)
18, 18B Analysis device (image processing device)
21 Application processing unit
24, 24B Storage unit
27B Narrowband image generation unit (conversion processing unit)
AP Spectroscopy application
C2 Post-adjustment narrowbanding coefficient (coefficient, coefficient matrix)
F2 Coefficient calculation unit
F5 Coefficient calculation unit
F11 Narrowbanding processing unit (conversion processing unit)
F12 Application generation unit
F32 Coefficient calculation unit
M2 Subject analysis AI model (AI model)
OP1 First sensor output
OP2 Second sensor output

1. An information processing device comprising:
a coefficient calculation unit configured to calculate a coefficient included in a conversion algorithm for converting first sensor output into different output, the first sensor output being spectral information output by a first spectroscopic sensor, wherein
the coefficient calculation unit calculate the coefficient so that the different output obtained by inputting the first sensor output to the conversion algorithm approaches second sensor output, the second sensor output being spectral information output by a second spectroscopic sensor different from the first spectroscopic sensor.

2. The information processing device according to claim 1, wherein the conversion algorithm is a matrix operation using a coefficient matrix in which a plurality of the coefficients is disposed in N rows and M columns where N is the number of wavelengths of the first sensor output input to the conversion algorithm and M is the number of wavelengths of the different output output from the conversion algorithm.

3. The information processing device according to claim 2, wherein the matrix operation also serves as a narrowbanding process of estimating output for a larger number of wavelengths than the number of input wavelengths by setting the M to a value larger than the N.

4. The information processing device according to claim 1, wherein the coefficient calculation unit calculate the coefficient using a first wavelength characteristic that is sensitivity information with respect to a wavelength of the first spectroscopic sensor and a second wavelength characteristic that is sensitivity information with respect to a wavelength of the second spectroscopic sensor.

5. The information processing device according to claim 1, further comprising:
an application generation unit configured to generate a spectroscopy application by which predetermined performance is obtained in a case where the different output is input.

6. The information processing device according to claim 5, wherein the spectroscopy application performs an inference process using an AI model.

7. The information processing device according to claim 1, further comprising:
a sensor input estimation unit configured to estimate input to the first spectroscopic sensor and the second spectroscopic sensor; and
a sensor output estimation unit configured to estimate output from the first spectroscopic sensor and the second spectroscopic sensor, wherein the coefficient calculation unit calculates the coefficient on a basis of the estimated input and the estimated output.

8. The information processing device according to claim 7, wherein the sensor input estimation unit estimate the input using information for estimating a light source.

9. An information processing method performed by an information processing device, comprising:
performing a process of calculating a coefficient included in a conversion algorithm for converting first sensor output into different output, the first sensor output being spectral information output by a first spectroscopic sensor, wherein
the coefficient is calculated so that the different output obtained by inputting the first sensor output to the conversion algorithm approaches second sensor output, the second sensor output being spectral information output by a second spectroscopic sensor different from the first spectroscopic sensor.

10. A program readable by a computer device, the program causing the computer device
to execute calculating a coefficient included in a conversion algorithm for converting a first sensor output into different output, the first sensor output being spectral information output from a first spectroscopic sensor, and
to implement a function of calculating the coefficient so that the different output obtained by inputting the first sensor output to the conversion algorithm approaches second sensor output, the second sensor output being spectral information output by a second spectroscopic sensor different from the first spectroscopic sensor.

11. An information processing device comprising:
a conversion processing unit configured to input first sensor output, the first sensor output being spectral information output by a first spectroscopic sensor, to a conversion algorithm to convert the first sensor output into output different from the first sensor output, wherein
a coefficient included in the conversion algorithm is a coefficient calculated so that the different output obtained by inputting the first sensor output to the conversion algorithm approaches second sensor output, the second sensor output being spectral information output by a second spectroscopic sensor different from the first spectroscopic sensor.

12. The information processing device according to claim 11, wherein
the conversion algorithm is a matrix operation using a coefficient matrix in which a plurality of the coefficients is disposed in N rows and M columns where N is the number of wavelengths of the first sensor output input to the conversion algorithm and M the number of wavelengths of the different output output from the conversion algorithm.

13. The information processing device according to claim 12, wherein
the conversion algorithm includes a narrowbanding process of estimating output for a larger number of wavelengths than the number of input wavelengths.

14. The information processing device according to claim 11, further comprising:
an application processing unit configured to input the different output to a spectroscopy application that performs a predetermined process by inputting spectral information to obtain a processing result of the predetermined process, wherein
the spectroscopy application is optimized to obtain predetermined performance in a case where the different output is used as input data.

15. The information processing device according to claim 14, wherein the spectroscopy application performs an inference process using an AI model.

16. An information processing method performed by an information processing device, comprising:
performing a process of inputting first sensor output, the first sensor output being spectral information output by a first spectroscopic sensor, to a conversion algorithm to convert the first sensor output into output different from the first sensor output, wherein
a coefficient included in the conversion algorithm is a coefficient calculated so that the different output obtained by inputting the first sensor output to the conversion algorithm approaches second sensor output, the second sensor output being spectral information output by a second spectroscopic sensor different from the first spectroscopic sensor.

17. An image processing device comprising:
a storage unit that stores a spectroscopy application that performs a predetermined process with second sensor output as input, the second sensor output being spectral information output by a second spectroscopic sensor different from a first spectroscopic sensor; and
an application processing unit configured to input the second sensor output to the spectroscopy application to obtain a processing result of the predetermined process, wherein
the spectroscopy application is optimized so as to obtain predetermined performance in a case where converted output obtained by applying predetermined conversion to first sensor output, the first sensor output being spectral information output by the first spectroscopic sensor, is used as input data, and wherein
the predetermined conversion is conversion using a conversion algorithm that brings the converted output close to the second sensor output.

18. An image processing method performed by an image processing device, comprising:
performing a process of storing a spectroscopy application that performs a predetermined process with second sensor output as input, the second sensor output being spectral information output by a second spectroscopic sensor different from a first spectroscopic sensor; and
performing a process of inputting the second sensor output to the spectroscopy application to obtain a processing result of the predetermined process, wherein
the spectroscopy application is optimized so as to obtain predetermined performance in a case where converted output obtained by applying predetermined conversion to first sensor output, the first sensor output being spectral information output by the first spectroscopic sensor, is used as input data, and
the predetermined conversion is conversion using a conversion algorithm that brings the converted output close to the second sensor output.
